(19) United States
(12) Patent Application Publication
(10) Pub. No.: US 2025/0326636 A1
(43) Pub. Date: Oct. 23, 2025

(54) APPARATUS AND METHODS GAS RECOVERY

(71) Applicant: Trimtabs Ltd, Swansea (GB)

(72) Inventors: Alvin ORBAEK WHITE, Swansea (GB); Paul ELKS, Swansea (GB)

(21) Appl. No.: 19/183,028

(22) Filed: Apr. 18, 2025

Related U.S. Application Data
(60) Provisional application No. 63/635,975, filed on Apr. 18, 2024.

(51) Int. Cl. C01B 3/26; B01D 53/053; B01D 53/22; C01B 3/50; C01B 3/56; C01B 32/16

(52) U.S. Cl. CPC C01B 3/26; B01D 53/053; B01D 53/22; C01B 3/501; C01B 3/56; C01B 32/16; B01D 2253/102; B01D 2256/16; B01D 2257/708; C01B 2203/0277; C01B 2203/0405; C01B 2203/042; C01B 2203/048; C01P 2006/82

(57) ABSTRACT

Embodiments of the present disclosure generally relate to apparatus and methods for producing carbon nanomaterials and the collection, storage, and reuse of byproducts produced therefrom. In an embodiment is provided an apparatus that includes a reactor adapted to process a carbon containing feed, a product filter system coupled to the reactor, a fin fan cooling apparatus coupled to the product filter system, an effluent chiller coupled to the fin fan cooling apparatus, a gas/liquid separator coupled to the effluent chiller, a waste liquid containment unit coupled to the gas/liquid separator, an activated carbon filter coupled to the gas/liquid separator, and a process vent coupled to the activated carbon filter.

### CROSS-REFERENCE TO RELATED APPLICATIONS

This application claims benefit of U.S. provisional patent application Ser. No. 63/635,975, filed Apr. 18, 2024, which is herein incorporated by reference in its entirety.

### BACKGROUND

### Field

Embodiments of the present disclosure generally relate to apparatus and methods for producing carbon nanomaterials and the collection, storage, and reuse of byproducts produced therefrom.

### Description of Related Art

With the rapid growth of plastics production, plastic waste and single use plastic waste has become an increasingly important environmental issue. As a result, efforts to eliminate or reintegrate such plastic waste products have come forth such as chemical and mechanical recycling processes. However, waste plastics that undergo conventional mechanical or chemical recycling processes do not maintain their physical and mechanical integrity. Additionally, some plastics exhibit high thermal and chemical stability (e.g., thermosetting networks) presenting another challenge to recycling and reintegrating such materials into the consumer market.

Another route for recycling plastic waste involves the thermal conversion of such materials into different carbon nanomaterials. Carbon nanomaterials have been well documented to improve various properties of conventional plastics, such as modulus, toughness, gas barrier properties, thermal conductivity, and the like. However, conventional thermal conversion processes require high temperatures resulting in the production of assortment of various byproducts and gases (e.g., volatile organic compounds, char, etc.). These byproducts are often hazardous to the operator and the environment, and regularly discarded as waste. In addition, it may be desirable (if not necessary) to sequester one or more gaseous byproducts produced from such thermal conversion processes.

There is a need for new apparatus and methods of producing carbon nanomaterials and collecting, storing, and/or recycling byproduct materials and compounds produced therefrom.

### SUMMARY

Embodiments of the present disclosure generally relate to apparatus and methods for producing carbon nanomaterials and the collection, storage, and reuse of byproducts produced therefrom.

In an embodiment is provided an apparatus that includes a reactor adapted to process a carbon containing feed, a product filter system coupled to the reactor, a fin fan cooling apparatus coupled to the product filter system, an effluent chiller coupled to the fin fan cooling apparatus, a gas/liquid separator coupled to the effluent chiller, a waste liquid containment unit coupled to the gas/liquid separator, an activated carbon filter coupled to the gas/liquid separator, and a process vent coupled to the activated carbon filter.

In another embodiment is provided an apparatus that includes a reactor adapted to process a carbon containing feed, a product filter system coupled the reactor, a fin fan cooling apparatus coupled to the product filter system, an effluent chiller coupled to the fin fan cooling apparatus, a gas/liquid separator coupled to the effluent chiller, an activated carbon filter coupled to the gas/liquid separator, an H₂ recovery package coupled to the activated carbon filter, a process vent coupled to the H₂ recovery package, and a waste liquid recovery unit coupled to the gas/liquid separator.

In another embodiment is provided a method of making carbon nanomaterials and recovering byproducts therefrom. The method includes introducing a carbon containing feed to a reactor to produce a mixture comprising a carbon nanomaterial and a gaseous byproduct. The method further includes filtering the carbon nanomaterials from the mixture in a product filter system coupled to the reactor to obtain the gaseous byproduct. The method further includes cooling the gaseous byproduct in a cooling system coupled to the product filter system to a temperature of about 0° C. to about 20° C. The method further includes separating the gaseous byproduct in a gas/liquid separator coupled to the cooling system to obtain a gaseous phase and a liquid phase. The method further includes removing H₂ gas from the gaseous phase to produce an H₂ gas and a waste gas. The method further includes venting the waste gas.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings.

It is to be noted, however, that the appended drawings illustrate only exemplary embodiments and are therefore not to be considered limiting of its scope, and may admit to other equally effective embodiments.

FIG. 1 is an overview of the general operating concept, according to an embodiment described herein.

FIG. 2 is an illustrative schematic of a reactor, according to an embodiment described herein.

FIG. 3 is an illustrative schematic of a product filter system, according to an embodiment described herein.

FIG. 4 is an illustrative schematic of a fin fan cooling apparatus, according to an embodiment described herein.

FIG. 5 is an illustrative schematic of an effluent chiller apparatus, according to an embodiment described herein.

FIG. 6 is an illustrative schematic of a gas/liquid separator, according to an embodiment described herein.

FIG. 7 is an illustrative schematic of a decanter vessel, according to an embodiment described herein.

FIG. 8 is an illustrative schematic of a pressure swing absorber, according to an embodiment described herein.

FIG. 9 is a flow chart showing selected operations of a method for processing a waste gas, according to an embodiment described herein.

FIG. 10 is a flow chart showing selected operations of a method for H₂ recovery and processing a waste gas, according to an embodiment described herein.

FIG. 11 is a flow chart showing selected operations of a method for H₂ recovery and for processing a waste gas, according to an embodiment described herein.

FIG. 12 is a flow chart showing selected operations of a method for H₂ recovery and for processing a waste gas, according to an embodiment described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to apparatus and methods for producing carbon nanomaterials and the collection, storage, and reuse of byproducts produced therefrom. Unlike conventional gas sequestering apparatus, apparatus configuration described herein according to one or more embodiments operates via a “free-draining” concept. That is to say that such apparatus configurations provide benefit by lessening and/or eliminating the need for additional and/or external pump requirements. Such a benefit lessons the input energy requirements of such apparatus. Furthermore, H₂ gas sequestering methods presented herein, according to some embodiments, provide process circularity in that H₂ gas not only is removed from the byproduct gas stream produced from carbon nanomaterial production and stored for later use, but also reintegrated into such carbon nanomaterial production processes as a carrier gas.

Apparatus and methods described herein are effective in gas (e.g., H₂) gas reclamation and/or reimplementation to said apparatus and methods as a carrier gas. Additionally, apparatus and methods described herein are effective in the reclamation of various solvents produced from and/or used in the conversion of the input feed material used with embodiments herein. Notably, apparatus described herein do not require specialized equipment to be effective in processing of waste byproducts produced from carbon nanomaterial production. Apparatus described herein may also be tailored to accommodate an operator's budget and byproduct collection desires. In addition, embodiments described herein are operable under a “free-draining” concept (e.g., no pumping requirements). As such, embodiments described herein may be performed under atmospheric pressure. As a result, intermediate and product streams may gravitationally flow from one unit (or operation thereof) to the next.

The term waste plastic, as utilized herein, includes material that is unused in and/or discarded from industrial manufacturing products and processes, post-manufacturing products and processes, or post-consumer products and processes. In the following description, it is understood that waste plastics may be substituted with waste polymers, paints, waste oils, plastic-coated paper, and plastic-coated cardboard, among other carbon-containing waste materials.

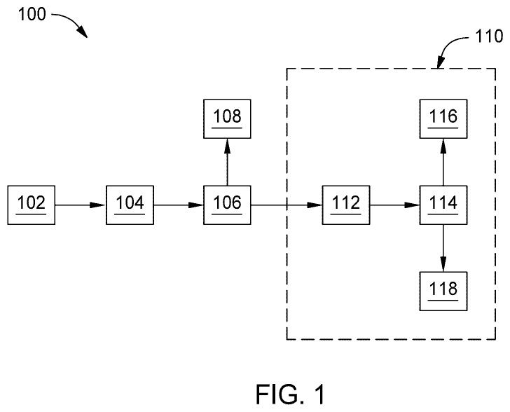

In general, embodiments described herein can broadly be described as apparatus and methods for forming carbonaceous materials and handling of the byproducts produced therefrom. FIG. 1 is an overview 100 of the general operating concept of methods described herein. Methods described herein include introducing a feed 102 to a reactor 104 wherein the feed 102 is vaporized and reacted to form various carbonaceous materials 108, such as carbon nanomaterials and/or carbon nanotubes (CNTs). The output from the reactor 104 is flowed to a separator/product filter 106 adapted to separate and capture carbonaceous material 108 (e.g., CNTs) and/or solid byproducts from the gaseous medium produced by vaporizing the feed 102 in the reactor 104. The gaseous medium is flowed from the separator/product filter 106 to a waste recovery/processing unit 110. The waste recovery/processing unit 110 may include a cooling system/apparatus 112 and a gas/liquid separator 114. The cooling system/apparatus 112 is adapted to controllably cool the gaseous medium to a condensation temperature, such that upon entering the gas/liquid separator 114 the gaseous medium condenses to form a gaseous output 116 and a liquid output 118. Additionally, the waste recovery/processing unit 110 include one or more apparatus/systems to discard, reuse, and/or collect and store the gaseous output 116 and liquid output 118.

### Feed

The feed 102 may include a carbon containing material such as plastic, waste plastic, polymers, or combinations thereof. The feed 102 may include a plastic and/or other suitable carbon containing material, a catalyst, and a solvent.

The carbon containing material does not include the catalyst and the solvent. The feed 102 may include the carbon containing material in an amount of about 0.1 wt % to about 40 wt %. The solvent of the feed 102 may be selected and/or varied depending on the composition of the plastic utilized.

Any suitable carbon containing material (e.g., plastic or waste plastic) that may be dissolved, dispersed, or suspended in a suitable solvent may be utilized as a feed 102. The choice of solvent may vary so long as the solvent does not substantially inhibit the growth of carbon nanomaterials. Suitable solvents may include benzene, toluene, cresylic acid, styrene, xylene, chlorobenzene, dichlorobenzene, ethylbenzene, propylbenzene, phenol, hydroxytoluene, pentane, hexane, derivatives and/or isomers thereof, or combinations thereof. The dissolution, dispersion, or suspension of the carbon containing material in the solvent may be mechanically perturbed by stirring, mixing, extraction, and/or sonication. The dissolution, dispersion, or suspension of the carbon containing material in the solvent may include heating.

Suitable plastics and waste plastics may include, but are not limited to, polyvinyl chloride (PVC), polystyrene (PS), bisphenol A resins, low density polyethylene (LDPE), polypropylene (PP), polymer resins, polyurethane, elastomers, polyolefins, cellulosic compounds, or combinations thereof. An advantage of the present disclosure is that plastics which are difficult to recycle, or even unrecyclable, by conventional processes may be utilized as the feed 102. For example, the feed 102 may include plastic materials containing colorants, fillers, and/or other additive materials or plastics contaminated with organic matter such as food residue.

The term catalyst includes compounds whose decomposition results in the formation of metal species that promotes the growth of carbonaceous materials 108 (e.g., carbon nanomaterials) from carbon containing precursor molecules. The catalyst may be selected based upon the miscibility with the solvent used to dissolve or suspend the plastic or other suitable carbon containing material.

Suitable catalyst may include, but are not limited to, metallocene molecules such as ferrocene (Fe(C₅H₅)₂), cobaltocene (Co(C₅H₅)₂), or nickelocene (Ni(C₅H₅)₂). Additionally, or alternatively, the catalyst can include metal halide compounds such as iron chloride materials (e.g., FcCl₃ and FeCl₂), nickel chloride materials (e.g., NiCl₂), cobalt chloride materials (e.g., CoCl₂), or copper chloride materials (e.g., CuCl₂). Additionally, or alternatively, the catalyst may include metal oxide materials, such as iron oxide materials (e.g., FeO, Fe₂O₃, and Fe₃O₄), nickel oxide materials (e.g., NiO and Ni₂O₃), or cobalt oxide materials (e.g., CoO, Co₂O₃, and Co₃O₄). Additionally, or alternatively, the catalyst may include metal nitrate compounds, including, but not limited to, iron nitrate materials (e.g., Fe(NO₃)₃), cobalt nitrate materials (e.g., Co(NO₃)₂), or nickel nitrate materials (e.g., Ni(NO₃)₂). Additionally, or alternatively, the catalyst may include metal acetylacetonate compounds, such as, but not limited to, iron acetylacetonate (Fc(C₅H₇O₂)₃), nickel acetylacetonate (Ni(C₅H₇O₂)₂), cobalt acetylacetonate (Co(CsH₇O₂)₂), gallium acetylacetonate (Ga(CsH₇O₂)₃), or ruthenium acetylacetonate (Ru(CsH₇O₂)₃). Combinations of catalysts may be utilized. The amount of catalyst in the feed 102, either as a single catalyst or a mixture of catalysts, that is used to obtain carbonaceous materials 108 (e.g., carbon nanomaterials) may be between about 0.0001% and about 50% (w/w) based on the amount of polymer in the feed 102, such as about 0.01% to about 5%.

The solvent, carbon containing material, and catalyst are mixed together to form a mixture. As described above, the carbon containing material is dissolved, dispersed, or suspended in the solvent and the catalyst is added to the solution, dispersion, or suspension, respectively, thus forming the mixture. In at least one embodiment, the mixture can be utilized as a feed 102.

### Reactor

As previously described, the general operating process illustrated in FIG. 1 includes introducing a feed 102 to a reactor 104 wherein the feed 102 is vaporized and reacted to form various carbonaceous materials 108, such as carbon nanomaterials and carbon nanotubes (CNT). The feed 102 may be introduced to the reactor 104 via injecting the feed 102, in the form of a solution, dispersion, or suspension, into a heated reactor 104 at a temperature effective to form carbonaceous materials 108. Such effective temperatures are also effective to decompose the carbon containing material in the feed 102 and activate the catalyst. Suitable temperatures to promote the formation of carbonaceous materials 108 may be from about 400° C. to about 1000° C., such as from about 600° C. to about 900° C., such as from about 700° C. to about 800° C.

The feed 102 may be injected into the reactor 104 with a carrier gas under conditions which facilitates carbonaceous material 108 growth/formation. The carrier gas may be hydrogen diluted in a noble gas such as helium, argon, or may be made of hydrogen diluted with an inert gas such as nitrogen, or combinations thereof. The carrier gas may be injected into the reactor 104 at a carrier gas flow rate that is from about 0.001 L/min and about 5000 L/min, such as between about 0.05 L/min and about 500 L/min, such as about 1 L/min to about 100 L/min, alternatively about 0.05 L/min to about 10 L/min. In one or more embodiments, the injection rate of the feed 102 to the reactor 104 is from 0.001 mL/min to about 5000 mL/min, such as from about 1 mL/min to about 5000 mL/min, such as from about 10 mL/min to about 5000 mL/min, such as from about 100 mL/min to about 2500 mL/min, such as from about 250 mL/min to about 1500 mL/min, alternatively about 100 mL/min to about 1500 mL/min.

In some embodiments, one or more methods described herein are solution based methods which are suitable for continuous processing. Such methods do not require operation as a batch reactor, which is beneficial for large-scale operations. For example, it is contemplated that a continuous introduction of the feed 102 into the reactor 104 may be utilized to increase the efficiency of methods and associated apparatus described herein. Additionally, it is contemplated that carbonaceous materials 108 may be collected using the separator/product filter 106 to enable the continuous processing envisioned by some embodiments described herein.

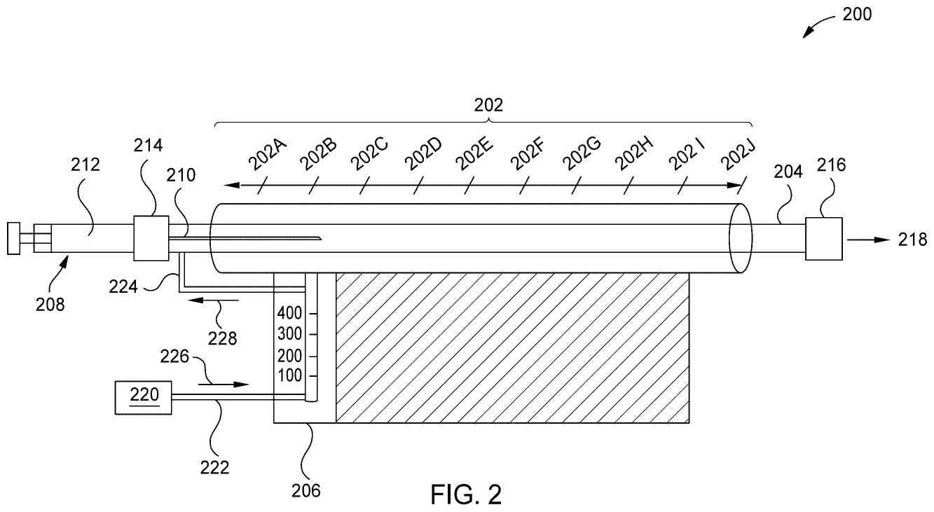

FIG. 2 illustrates a reaction vessel 200 that may be used as the reactor 104. The reaction vessel 200 may include a furnace, such as a multi-zone furnace 202. The multi-zone furnace 202 may be a separately controlled multi-zone furnace 202, wherein each of the zones of the separately controlled multi-zone furnace 202 can be independently controlled and operated. The separately controlled multi-zone furnace 202 may include any suitable number of zones such as from 1 to 10 zones, such as 2 to 8 zones, such as 4 to 6 zones. The separately controlled multi-zone furnace may include 1 to 2 zones, alternatively 2 to 4 zones, alternatively 6 to 8 zones, alternatively 8 to 10 zones, alternatively 1 to 5 zones, alternatively 5 to 10 zones. In at least one embodiment, the separately controlled multi-zone furnace 202 can include 10 zones as represented by zones 202A-202J respectively. Each of the one or more zones may be, independently, a vaporization zone, a gas heat zone, a reaction zone, or combinations thereof. When the feed 102 enters a vaporization zone, the carbon containing material, catalyst, and solvent are vaporized. The vaporized feed 102 is heated in one or more of the gas heat zones, such that the catalyst becomes active. When in one or more of the reaction zones, the catalyst interacts with the carbon containing material to promote growth of carbonaceous material 108 (e.g., carbon nanomaterials).

In some embodiments, the carbonaceous material 108 growth occurs on the inside walls of a tube 204 in one or more of the zones. The tube 204 may be composed of any one or more materials suitable for preparing carbonaceous material from the feed. The tube 204 may be composed of steel or quartz. In such embodiments, the tube 204 serves as a substrate for the growth of the carbonaceous material 108. The multi-zone furnace 202 may include one or more heating coils adapted to maintain a stable temperature of up to about 1000° C. for one or more zones of the multi-zone furnace 202. The multi-zone furnace 202 may include a proportional-integral-derivative (PID) controller utilized to maintain the temperature within a range of about +0.1° C. from a predetermined temperature.

The reaction vessel 200 may include a gas flow controller 206. A tube 204 is disposed within the multi-zone furnace 202 and extends laterally within the multi-zone furnace 202 such that the multi-zone furnace 202 surrounds the tube 204. A length of the tube 204 may be in the range of about 1 m to about 5 m, such as about 1.5 m to about 4 m, such as about 2 m to about 3.5 m. The tube 204 may have an inner diameter in the range of about 12 mm to about 100 mm, such as about 20 mm to about 80 mm, such as about 25 mm to about 50 mm.

An injector 208 is coupled to the tube 204 and in fluid communication with a volume 205 of the tube 204 via an inlet 210. The injector 208, includes a volume 212 which is loaded with the feed 102. The injector 208 may be a pump capable of introducing the feed 102 to the volume 205 of the tube 204 at an injection rate of about 10 mL/min to about 5000 mL/min, such as from about 100 mL/min to about 2500 ml/min, such as from about 250 mL/min to about 1500 mL/min, alternatively about 100 mL/min to about 1500 mL/min. The pump may inject the feed 102 through the inlet 210 into the tube 204. Alternatively, a micro pump may be utilized to fill the volume 212 of the injector 208 prior to injection of the feed 102 to the tube 204. The injector 208 is connected to the tube 204 via a first coupling 214 and the inlet 210 extends from the injector 208 through the first coupling 214 and into the volume 205 of the tube 204. In one example, the inlet 210 extends a distance into the tube 204 corresponding to the first zone 202A of the multi-zone furnace 202. As such, the first coupling 214 is disposed adjacent to and may define a terminus of the first zone 202A.

A second coupling 216 is connected to the tube 204 opposite the first coupling 214. The second coupling 216 enables connection to a reactor effluent stream 218 and the second coupling 216 may define a terminus of the final zone (e.g., 202J) of the multi-zone furnace 202. In certain embodiments, both of the first coupling 214 and the second coupling 216 are stainless steel flanges designed as quartz-to-hose type connectors.

A carrier gas source 220 is in fluid communication with the volume of the tube 204. The carrier gas source 220 is coupled to a gas flow controller 206 via a first conduit 222. A second conduit 224 couples the gas flow controller 206 to the volume of the tube 204. A flow path 226 of the carrier gas extends from the carrier gas source 220 to the gas flow controller 206 via the first conduit 222 and a flow path 228 of the carrier gas extends from the gas flow controller 206 to the volume of the tube 204 via the second conduit 224.

### Product Filter Apparatus

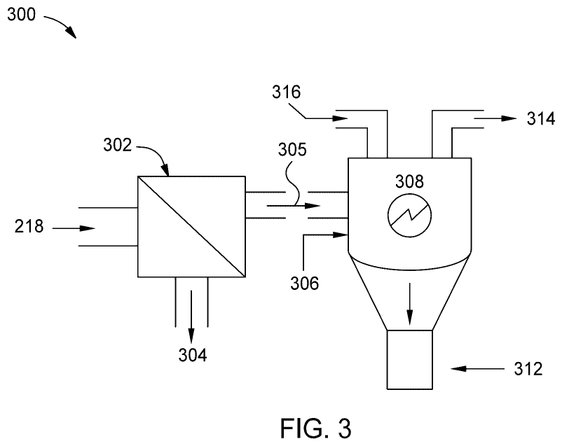

The second coupling 216 may be directly connected to a product filter system 300 such that the reactor effluent stream 218 exiting the multi-zone furnace 202 enters immediately into the product filter apparatus. In one or more embodiments, a product filter system 300 is generally illustrated by FIG. 3, wherein FIG. 3 is a general flow path diagram of the reactor effluent stream 218 entering and flowing through the product filter system 300.

The reactor effluent stream 218 from the multi-zone furnace 202 may be flowed to a product filter system 300 wherein the reactor effluent stream 218 first enters a catalyst separation unit 302. The catalyst separation unit may be configured to separate catalyst particles of a certain size from the reactor effluent stream 218 to form separated catalyst particles 304 and a catalyst separated effluent stream 305.

The separated catalyst particles 304 may be collected, stored, recycled, reused, or combinations thereof via any suitable method in the art. The catalyst separation unit 302 may be configured to include any suitable separator apparatus, such as a cyclonic separator, a magnetic separator, a settling tank, and the like. The catalyst separation unit 302 can adopt multiple and/or additional separation apparatus, including those not explicitly disclosed herein.

The catalyst separated effluent stream 305 flows from the catalyst separation unit 302 to a product filter apparatus 306, which is configured to separate and collect carbonaceous materials 108 in a product capture vessel 312. The product filter apparatus 306 may be configured to include an separation mechanism 308 which is designed to effectively remove and collect the carbonaceous product materials from the catalyst separated effluent stream 305, thereby producing a filtered effluent stream 314. The separation mechanism 308 may include any suitable mechanisms and/or separators, such as a cyclonic separator, a multicyclonic separator, an electrostatic precipitator, a magnetic separator, an inertial separator, a gravity separator, a filter, or combinations thereof. When the separation mechanism 308 includes a filter and/or filter mechanism, the filter may include a sintered ceramic filter, a sintered metal filter, or combinations thereof. The product filter apparatus 306 may be further configured to include an input nitrogen supply 316.

Additionally or alternatively, the product filter system 300 of the present disclosure can include any one or more apparatus and/or methods disclosed by Denton et al., U.S. Pat. No. 10,343,104, as incorporated herein by reference.

### Waste Processing/Recovery Unit

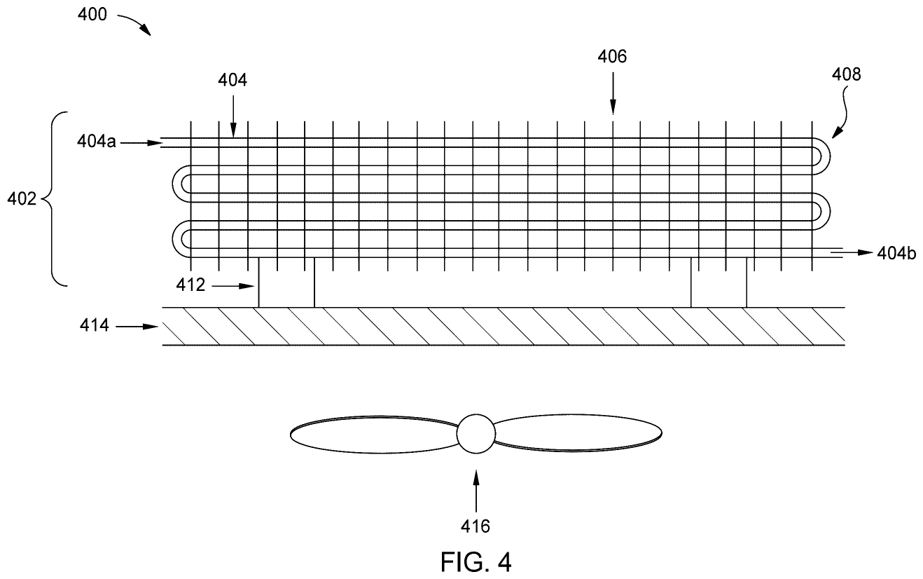

The cooling system/apparatus 112 of the waste processing/recovery unit 110 may include a fin fan cooling apparatus 400, as generally illustrated in FIG. 4. More than one fin fan cooling apparatus may be utilized if desired. The fin fan cooling apparatus 400 may be configured to reduce the temperature of a filtered effluent stream 314 as it enters and flowed throughout the cooling system/apparatus 112. A fin fan cooling apparatus 400 of the present disclosure may incorporate any suitable components, configurations, and/or designs known to one of ordinary skill in the art. For example, the fin fan cooling apparatus 400 may be configured as an induced draft air cooler or a forced draft air cooler. Generally, air-cooled exchangers, such as fin fan cooling apparatus 400, include a finned tube bundle 402 mounted in connection to a fan deck 414, by a connecting structure 412, and configured to distribute the air evenly across the finned tube bundle 402. The finned tube bundle 402 includes any suitable number of piping loops 408 such that the filtered effluent stream 314 travels repeatedly back and forth through the piping loops 408, wherein the piping loops 408 are exposed or continuously exposed to flowing air from the fan 416 provided by the fan deck 414. The fin fan cooling apparatus 400 may include 1 to 100 piping loops 408, such as 1 to 50 piping loops 408, such as 1 to 25 piping loops 408, such as 1 to 10 piping loops 408.

Pipe 404 is a part of the finned tube bundle 402, through which the filtered effluent stream 314 flows through as it is cooled. Pipe 404 may be coupled to the product filter system 300 such that the filtered effluent stream enters the fin fan cooling apparatus 400 at a pipe inlet 404a of the pipe 404. The filtered effluent stream 314 flows through the pipe 404 of the fin fan cooling apparatus 400 and is cooled, before exiting the pipe at the pipe outlet 404b. A length of the pipe 404 implemented in the finned tube bundle 402 may correlate to the distance the filtered effluent stream 314 must travel during cooling within the fin fan cooling apparatus 400, and thus may affect the degree of cooling that the filtered effluent stream 314 experiences. The pipe 404 implemented in the finned tube bundle 402 may include a length, as measured from the pipe inlet 404a to the pipe outlet 404b, of about 1 m to 100 m, such as about 1 m to 10 m, such as about 1 m to about 5 m, such as about 1 m to about 2.5 m. The pipe 404 used in the fin fan cooling apparatus 400 may be made from carbon steel, stainless steel, duplex, copper, aluminum, Incoloy 310, Incoloy 600, Incoloy 800, Inconel 310, Inconel 600, Inconel 800, or a combination thereof. The material selection of the pipe 404 can affect heat dissipation and cooling efficiency of the fin fan cooling apparatus 400.

The finned tube bundle also includes fins 406. Fins 406 serve to dissipate heat from the fin fan cooling apparatus 400 resulting from the filtered effluent stream 314 flowing therein. The fins 406 of the may have a fin height of about 6.35 mm to about 25.5 mm, such as about 12.8 mm to about 15.9 mm. The fins 406 may have a fin thickness of about 0.3 mm to about 1.5 mm, such as about 0.7 mm to about 1 mm. The fins 406 may be selected from one or more fin types including edge found fins, footed tension fins, extruded fins, embedded fins, double footed tension fins, footed grooved tension fins, laser-welded fins, or a combination thereof. The fins 406 of the fin fan cooling apparatus 400 may be made of one or more materials selected from aluminum, carbon steel, galvanized carbon steel, stainless steel, duplex, copper, Incoloy 310, Incoloy 600, Incoloy 800, Inconel 310, Inconel 600, Inconel 800, or a combination thereof, or a combination thereof.

The fin fan cooling apparatus 400 may include any suitable number of fans (e.g., fan 416), such as 1 to 50 fans, such as 1 to 25 fans, such 1 to 10 fans, such as 1 to 5 fans. The fans 416 serve to provide a flow path by which to further dissipate heat from the fin fan cooling apparatus 400 resulting from the filtered effluent stream 314 flowing therein.

It should be noted that any one or more embodiments pertaining to one or more components, configurations, and/or designs of the fin fan cooling apparatus 400 may be tailored/tuned for a desired application. For instance, the fin fan cooling apparatus 400 of the present disclosure may be configured to reduce the temperature of a filtered effluent stream 314 exiting the fin fan cooling apparatus 400 to a temperature of about 50° C. to about 100° C., such as about 50° C. to about 75° C., such as about 50° C. to about 65° C.

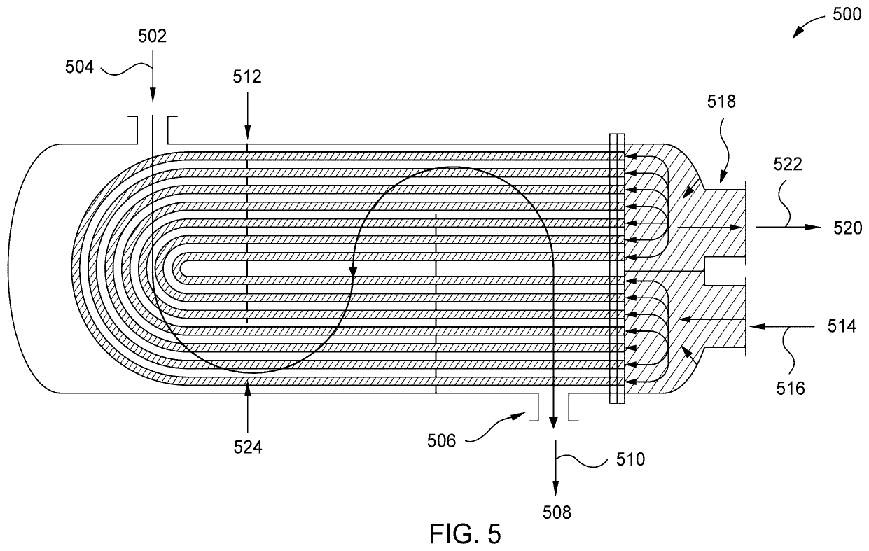

The cooling system/apparatus 112 of the waste processing/recovery unit 110 may include an effluent chiller 500, as generally illustrated in FIG. 5. More than one effluent chillers may be used. The effluent chiller 500 may be coupled to the fin fan cooling apparatus 400 such that the filtered effluent stream 314 exits the pipe outlet 404b and enters the effluent chiller 500 at either the shell side fluid inlet 504 or the tube side fluid inlet 514. The effluent chiller 500 may be configured to reduce and maintain the temperature of a filtered effluent stream 314 flowing therein at a about 0° C. to about 20° C., such as about 5° C. to about 15° C., such as about 5° C. to about 10° C. The effluent chiller 500 of the present disclosure may be any suitable heat exchanger apparatus known to one of ordinary skill in the art. The effluent chiller 500 of the present disclosure may be a shell and tube type heat exchanger 502, typically in a horizontal orientation, wherein a filtered effluent stream 314 can flow therein.

The shell and tube type heat exchanger 502 may be configured such that the filtered effluent stream 314 flowing therein enters and exits the shell and tube type heat exchanger 502 via a shell side connection or a tube side connection. For example, a shell side connection may include a shell side fluid inlet 504 wherein a gaseous composition 506 (e.g., the filtered effluent stream 314) enters the shell and tube type heat exchanger 502 via the shell side fluid inlet 504, flows along a predetermined flow path, and exits the shell and tube type heat exchanger 502 via a shell side fluid outlet 508 to provide a gas/liquid mixture 510. The gas/liquid mixture 510 is produced from condensing the gaseous composition 506 within the shell and tube type heat exchanger 502 via contacting the gaseous composition 506 with one or more tubes 524 having a cooling medium flowing therein via a tube side fluid inlet 514 and a tube side fluid outlet 518. The predetermined flow path of a shell and tube type heat exchanger 502 with a shell side connection may be dictated by one or more baffles 512 implemented therein. The one or more baffles 512 may be positioned/oriented to increase the time of contact between the gaseous composition 506 and the one or more tubes 524 containing cooling medium, thereby increasing the degree of cooling the gaseous composition 506 and/or gas/liquid mixture 510 experiences prior to exiting the shell and tube type heat exchanger 502 via the shell side fluid outlet 508.

Alternatively, a tube side connection of the shell and tube type heat exchanger 502 may include a tube side fluid inlet 514 wherein the gaseous composition 516 enters the shell and tube type heat exchanger 502 via the tube side fluid inlet 514, flows along a predetermined flow path determined by one or more tubes 524, and exits the shell and tube type heat exchanger 502 via a tube side fluid outlet 518 to provide a gas/liquid mixture 522. The gas/liquid mixture 522 is produced from condensing the gaseous composition 516 within the shell and tube type heat exchanger 502 via contacting the one or more tubes 524 containing the gaseous composition 516 with a cooling media flowing along a flow path within the shell as determined by a shell side fluid inlet 504, one or more baffles 512, and a shell side fluid outlet 508. The shell and tube type heat exchanger 502 having a tube side connection can be configured to increase the degree of cooling the gaseous composition 516 and/or gas/liquid mixture 522 experiences prior to exiting the shell and tube type heat exchanger 502 via a tube side fluid outlet 518.

The shell and tube type heat exchanger 502 may be configured such that the flow path, by which the gaseous composition (506 or 516) and cooling media flow along, is selected from a parallel flow, a counter flow, a cross flow, or a combination thereof. The shell and tube type heat exchanger 502 may include any suitable number of tubes 524 such as 10 tubes to 500 tubes, such as 50 tubes to 400 tubes, such as 100 tubes to 350 tubes, such as 150 tubes to 320 tubes. One or more of the tubes 524 of the shell and tube type heat exchanger 502 may be made from carbon steel, stainless steel, titanium, Inconel, Inocoloy, copper, or a combination thereof. One or more of the tubes 524 of the shell and tube type heat exchanger 502 may have a diameter of about 6.35 mm to about 25.4 mm, such as about 12.7 mm to about 19.5 mm. The thickness of one or more of the tubes 524 of the shell and tube type heat exchanger 502 may be selected such that the tubes exhibit a resistance to the pressure, temperature, thermal stress, and corrosive cooling media expressed upon the tubes over a tubular distance (e.g., tube length of the exchanger) of about 0.5 m to about 4 m, such as about 0.5 m to about 3 m, such as about 1 m to about 2 m. The shell and tube type heat exchanger may include any suitable number of baffles 512 such as 1 to 25 baffles, such as 1 to 10 baffles, such as 1 to 5 baffles.

It should be noted that any one or more embodiments pertaining to one or more components, configurations, and/or designs of the effluent chiller 500 may be tailored/tuned for a desired application. For example, the effluent chiller 500 of the present disclosure may be configured as a shell and tube type heat exchanger 502 to condense of a gaseous stream flowing through the effluent chiller 500, and cooling such contents to a temperature of about 0° C. to about 20° C., such as about 5° C. to about 15° C., such as about 5° C. to about 10° C. to produce a gas/liquid mixture (510 or 522).

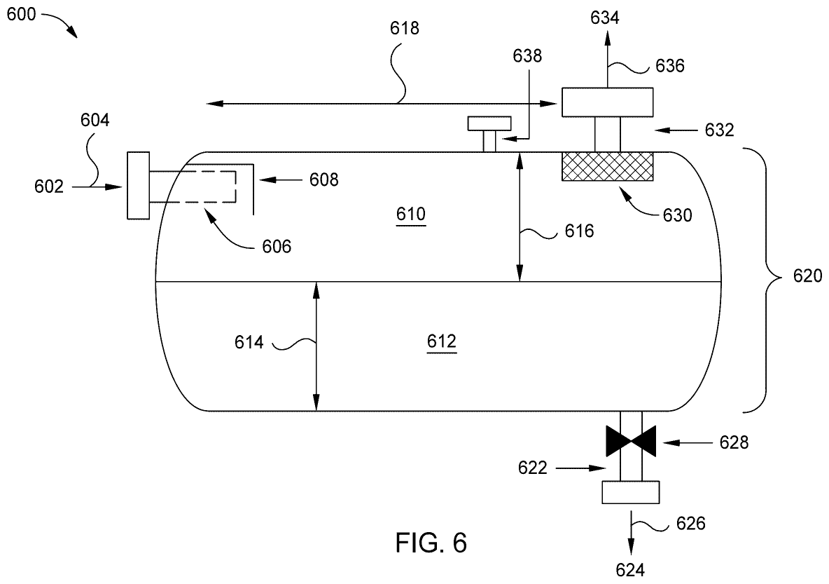

A waste processing/recovery unit 110 may include one or more gas/liquid separators 114, such as the gas/liquid separator 600 as generically illustrated in FIG. 6. The gas/liquid separator 600 can be or include any one or more phase separation apparatus known to one of ordinary skill in the art. The gas/liquid separator 600 may include a tube-like apparatus oriented in the vertical or horizontal direction. The gas/liquid separator 600 may include a diameter 620 of about 15.2 cm to about 60.9 cm, such as about 15.2 cm to about 45.7 cm, such as about 15.2 cm to about 30.4 cm. The length of the gravity separation section 618 of the gas/liquid separator 600 may be about 0.5 m to about 3 m, such as about 1 m to about 2 m.

A gas/liquid separator 600 may include an inlet 602 equipped with an inlet device 606, through which a gas/liquid mixture 604 enters the gas/liquid separator 600, wherein the gas/liquid mixture 604 is flowed from an outlet of the effluent chiller 500 (e.g., the shell side fluid outlet 508 or the tube side fluid outlet 518). The inlet device 606 is configured to improve the separation gas/liquid separation performance of the gas/liquid separator 600. The inlet device 606 can include one or more suitable devices know to one of ordinary skill in the art such as, for example, a diverter plate 608. Upon entering the gas/liquid separator 600, the gas/liquid mixture 604 is able to segregate into a gaseous output 610 (previously referenced as 116 in FIG. 1) having a phase height 616 and a liquid output 612 (previously referenced as 118 in FIG. 1) having a phase height 614. The gas/liquid mixture 604 may be kept in the gas/liquid separator 600 for a residence time of about 1 hrs to about 24 hrs, such as about 4 hrs to about 24 hrs, such as about 6 hrs to about 24 hrs. A control valve 628 may be directly coupled to the bottom of the gas/liquid separator 600, wherein the control valve 628 is configured to control and/or maintain the volume in which the liquid output 612 occupies within the gas/liquid separator 600. The control valve 628 may be fully opened to remove the liquid output 612 from the gas/liquid separator 600 via a liquid phase outlet 622, wherein the removed liquid phase 626 is collected and stored within an appropriate liquid waste storage/containment unit 624. The removed liquid phase 626 may include water, one or more solvents, and/or one or more volatile organic compounds/content (VoCs). The gas/liquid separator 600 may include a mist extraction apparatus 630 positioned between a gas phase outlet 632 and the interior of the gas/liquid separator 600. The mist extraction apparatus 630 is implemented to improve the separation of residual solvents and/or other VoCs from the extracted gas phase 636 during removal from the interior of the gas/liquid separator 600 via the gas phase outlet 632, and transit therefrom to any one or more suitable gas phase processing apparatus 634. The mist extraction apparatus 630 can be a mesh pad extractor, a vane-type extractor, an axial flow demisting cyclone, or a combination thereof.

The control valve 628 is configured to control and/or maintain the volume in which the liquid output 612 occupies within the gas/liquid separator 600. Without being bound by theory, the ability to control the volume of the liquid output 612 within the gas/liquid separator 600 allows an operator an additional handle by which to control the as flow rate of the extracted gas phase 636 through the gas phase outlet. By controlling the level of the liquid output 612, an operator is able to control/monitor (via a pressure gauge 638) the vapor pressure of the gaseous output610 within the gas/liquid separator 600.

It should be noted that any one or more embodiments pertaining to one or more components, configurations, and/or designs of the gas/liquid separator 600 may be tailored/tuned for a desired application. For instance, the gas/liquid separator 600 of the present disclosure is configured to separate the condensed volatile content from the extracted gas phase 636. Additionally or alternatively multiple (e.g., 1 to 5) gas/liquid separators 600 may be configured in series to ensure adequate separation of the gaseous output 610 and liquid output 612.

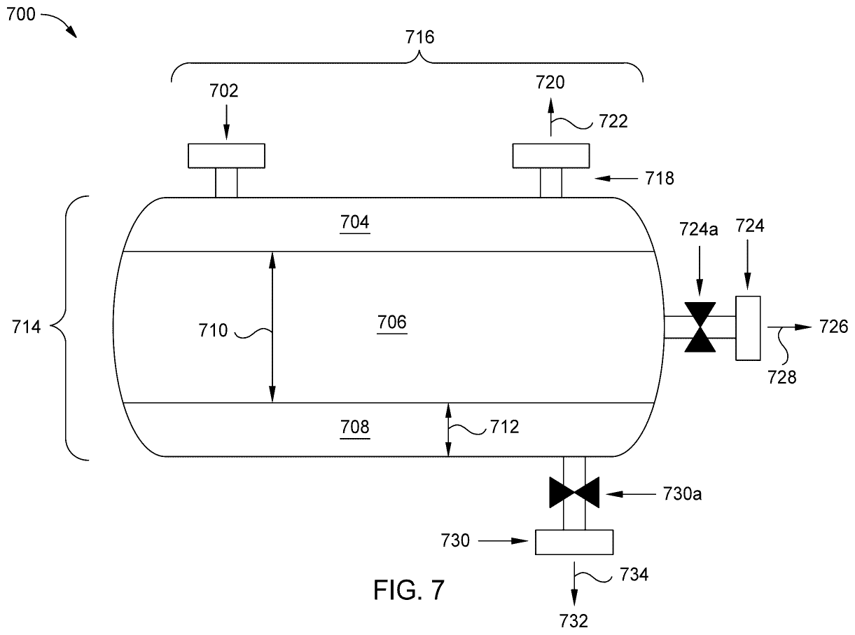

A waste processing/recovery unit 110 may include one or more decanter vessels 700, by which the liquid output 118 may be separated into aqueous and organic phases. FIG. 7 shows a generic illustration of a decanter vessel 700.

The decanter vessel 700 can be and/or include any one or more apparatus known to one of ordinary skill in the art. The decanter vessel 700 can include a tube-like apparatus oriented in the vertical or horizontal direction. The decanter vessel 700 may have a diameter 714 of about 0.2 m to about 1.5 m, such as about 0.3 m to about 1 m, such as about 0.4 m to about 0.6 m. The decanter vessel 700 has a length 716 of about 1 m to about 5 m, such as about 1.5 m to about 3 m, such as about 2 m to about 2.5 m.

The decanter vessel 700 receives a waste liquid input (e.g., the removed liquid phase 626 of the gas/liquid separator 600) via an inlet 702 wherein the waste liquid input is allowed to separate into a low density phase 706 having a phase height 710 and a high density phase 708 having a phase height 712. The residence time necessary for the low density phase 706 and the high density phase 708 to separate is about 4 hrs to about 24 hrs, such as about 5 hrs to about 15 hrs, such as about 6 hrs to about 10 hrs. The decanter vessel 700 further includes a low density phase outlet 724 coupled to a valve 724a, a high density phase outlet 730 coupled to a valve 730a, and a vent 718. The low density phase outlet 724 may be configured such that when the valve 724a is opened, the low density liquid 728 may flow 726 from the decanter to a suitable liquid containment unit. The high density phase outlet 730 is configured such that such that when the valve 730a is opened, the low density liquid 734 may flow 732 from the decanter to a suitable liquid containment unit. The vent 718 is configured such that outgas 722 from the headspace 704 and transferred to a suitable gas processing unit 720 or vented to the atmosphere.

It should be noted that any one or more embodiments pertaining to one or more components, configurations, and/or designs of the decanter vessel 700 may be tailored/tuned for a desired application. For instance, the decanter vessel 700 of the present disclosure is configured to separate a waste liquid input 702 into a low density phase 706 and a high density phase 708.

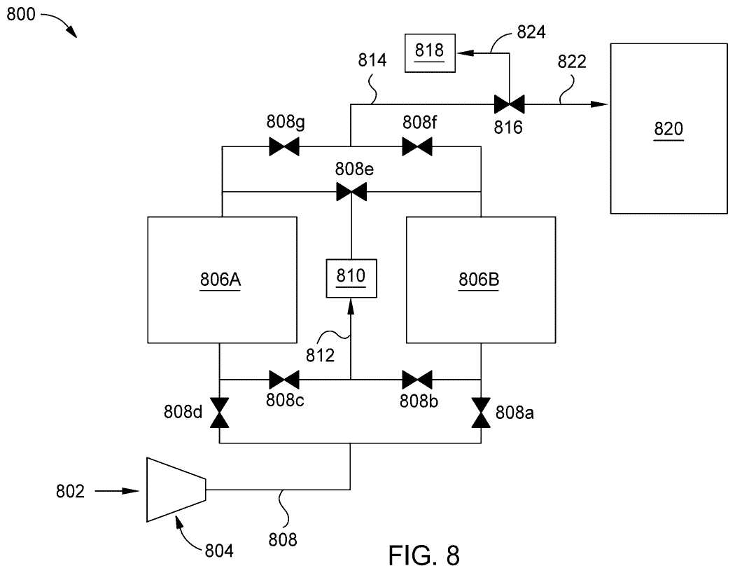

A waste processing/recovery unit 110 may include an apparatus by which to collect and/or process the gaseous output 116, such as an H₂ recovery package. An H₂ recovery package may include any suitable gas recovery/processing unit, such as a pressure swing absorber (PSA). FIG. 8 shows an exemplary PSA 800. The PSA 800, as described herein, may be implemented as a means to clean, process, store, and/or reuse a H₂ rich gas stream. In at least one embodiment, the H₂ recovery package includes a temperature swing absorber. It will be appreciated by one of ordinary skill in the art that the H₂ recovery package is not limited to a PSA, and may include any one or more suitable apparatuses capable of collecting and/or processing the gaseous output 116. In one or more embodiments, the H₂ recovery package includes one or more recovery membranes, one or more absorbant materials/technologies, a cryogenic separation unit, and combinations thereof.

Generally, the pressure swing absorption process includes process steps for absorption, depressurization, regeneration, and repressurization. Absorption is carried out at high pressures wherein a feed gas 802 is introduced to a compressor 804 to produce a pressurized feed gas which is directed to a first absorption tower 806A via line 808 and a series of directional control valves (808a, 808b, 808c, and 808d). The first absorption tower 806A can contain any one or more absorbents know to one of ordinary skill in the art such as any one or more zeolites, activated carbon, silica gel, alumina, synthetic resins, molecular sieves, metal-organic frameworks (MOFs), or a combination thereof. In some embodiments, the pressurized feed is flowed to the first absorption tower 806A for a suitable time and pressure until the absorbent becomes saturated with the target gas. The pressurized feed may be flowed to the first absorption tower 806A for about 5 min to about 45 min such as about 5 min to about 30 min, such as about 10 min to about 30 min. The pressurized feed gas may be flowed to the first absorption tower 806A at a pressure of about 5 barg to about 60 barg, such as about 5 barg to about 45 barg, such as about 10 barg to about 30 barg.

Depressurization starts in the co-current direction from bottom to top of the first absorption tower 806A, as controlled by a series of directional valves (808e, 808f, and 808g). In one or more embodiments, H₂ gas remains in the void space of the absorption material and is used to pressurize another absorption tower (e.g., absorption tower 806B) having just terminated its regeneration, so as to equalize the pressure between the two. It should be noted that although FIG. 8 illustrates two absorption towers (806A and 806B), the PSA 800 can include any suitable number of absorption towers, such as 1 to 20 absorption towers, such as 1 to 10 absorption towers, such as 1 to 4 absorption towers. Additionally, the PSA 800 can be configured to include any suitable number of directional valves in any configuration, as determined by the number and location of the absorption towers. Depending on the total number of absorption towers and the process conditions, a suitable number of these pressure equalization steps may be performed performed.

Each additional pressure equalization step minimizes hydrogen losses and increases the hydrogen recovery rate. The remaining pressure must be released in the counter-current direction to prevent break-through of impurities at the top of the first absorption tower 806A. The target gas of a separate absorption tower (e.g., 806B) is then introduced as a purge gas for the first absorption tower 806A, wherein the first absorption tower is purged of desorbed impurities and expelled via a process vent 810 via line 812 and a series of direction valves (e.g., 808a-808g). The first absorption tower 806A is then repressurized via a depressurization of a separate absorption tower (e.g., 808B), so as to equalize the pressure between the two. Throughout operation of the PSA 800, the product gas may be continually flowed to a master control valve 816 via line 814. In one or more embodiments, the orientation of the master control valve 816 determines the flow direction of the product gas, and directs a product gas to either a product gas storage/containment unit 820 via line 822 or to a recycle/reuse gas stream 818 via line 824.

### Production and Recovery Methods

Embodiments described herein may be utilized to collect, store, and/or reuse of H₂ gaseous byproducts produced from the production of carbonaceous materials. These and other embodiments may operate under a “free-draining” concept (e.g., no pumping requirements). As such, embodiments described herein may be performed at atmospheric pressure and, as a result, gravitationally flow from one unit and/or process to the next. Additionally, embodiments described herein can be designed and/or configured to accommodate a feed 102 at small and/or large volume throughput.

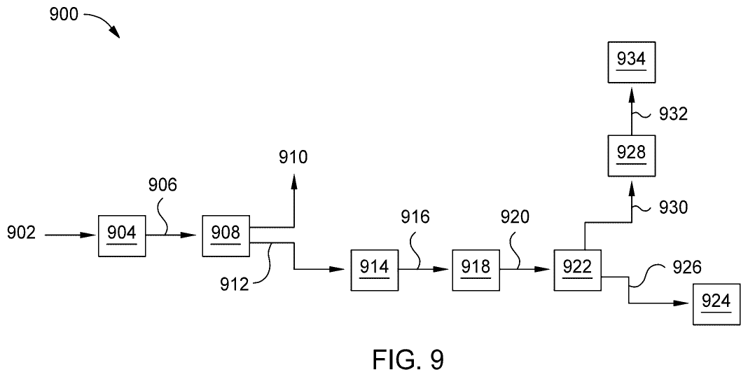

A method of processing waste gas produced as a byproduct from the production of carbonaceous materials production can be illustrated by FIG. 9. The method 900 includes introducing a feed 902 (e.g., feed 102) to a reactor 904 (e.g., reaction vessel 200) to produce one or more carbonaceous materials 910 (e.g., carbon nanomaterials) and a gaseous byproduct. The feed 902 may include any suitable feed composition described herein. The reactor 904 may be coupled to, either directly or indirectly, the product filter apparatus 908 (e.g., product filter system 300) such that the carbonaceous materials 910 and gaseous byproducts are transferred from the reactor 904 to the product filter apparatus 908 via line 906. The product filter apparatus 908 can adopt any one or more of the configurations previously described such that the carbonaceous materials 910 produced from the reactor 904 are completely removed from the gaseous byproduct stream, thereby producing a filtered effluent stream (e.g., filtered effluent stream 314). The product filter apparatus 908 may be coupled to, either directly or indirectly, a fin fan apparatus 914 (e.g., fin fan cooling apparatus 400), such that the filtered effluent stream produced from the product filter apparatus 908 is flowed therefrom to the fin fan apparatus 914 via line 912. The fin fan apparatus 914 can adopt any one or more of the configurations previously described such that the filtered effluent stream produced from the product filter apparatus 908 is sufficiently cooled to a temperature of about 50° C. to about 100° C., such as about 50° C. to about 75° C., such as about 50° C. to about 65° C., thereby producing a cooled effluent stream. The fin fan apparatus 914 may be coupled to, either directly or indirectly, an effluent chiller apparatus 918 (e.g., effluent chiller 500), such that the cooled effluent stream produced from the fin fan apparatus 914 is flowed therefrom to the effluent chiller apparatus 918 via line 916. The effluent chiller apparatus 918 can adopt any one or more of the configurations previously described such that the cooled effluent stream produced from the fin fan apparatus 914 is sufficiently chilled to a temperature of about 0° C. to about 20° C., such as about 5° C. to about 15° C., such as about 5° C. to about 10° C. to condense the cooled effluent stream, thereby producing a gas/liquid mixture (e.g., gas/liquid mixture 522). The effluent chiller apparatus 918 may be coupled to, either directly or indirectly, a gas/liquid separator 922 (e.g., gas/liquid separator 600), such that the gas/liquid mixture produced from the effluent chiller apparatus 918 is flowed therefrom to the gas/liquid separator 922 via line 920. The gas/liquid separator 922 can adopt any one or more of the configurations previously described such that the gas/liquid mixture produced from the effluent chiller apparatus 918 is able to sufficiently separate the product gas (e.g., gaseous output 116 and/or gaseous output 610) and waste liquid output (e.g., liquid output 118 and/or liquid output 612).

In one or more embodiments, the gas/liquid separator 922 is configured to include a control valve (e.g., control valve 628) and a liquid outlet (e.g., liquid phase outlet), wherein the control valve separates the gas/liquid separator from the liquid outlet. The liquid outlet may be coupled to, either directly or indirectly, a waste liquid containment unit 924, such that the control valve separating the gas/liquid separator 922 from the liquid outlet can be opened enough to both maintain a sufficient vapor pressure in the headspace of the gas/liquid separator 922 and flow excess waste liquid output from the gas/liquid separator 922 to the waste liquid containment unit 924 via line 926. The waste liquid containment unit 924 is configured to have robust physical and mechanical properties such that it provides safe and stable storage and transport therefrom to a suitable waste treatment facility.

Additionally or alternatively, the gas/liquid separator 922 may be configured to include a mist extractor (e.g., mist extraction apparatus 630) coupled to a gas outlet (e.g., gas phase outlet 732) by which the product gas may be removed from the gas/liquid separator 922. Without being bound by theory, the vapor pressure present in the headspace of the gas/liquid separator 922 provides a sufficient force to flow the process gas output through the mist extractor and the gas outlet coupled thereto. In at least one embodiment, the gas outlet is coupled to, either directly or indirectly, a scrubber/activated carbon filter 928, such that the process gas output produced from the gas/liquid separator 922 may be flowed therefrom to the scrubber/activated carbon filter 928 via line 930. The scrubber/activated carbon filter 928 (e.g., a desiccant bed) is configured to remove any residual solvents/hydrocarbon solvents remaining in the process gas output from the gas/liquid separator 922 to produce a cleaned process gas. Additionally, the scrubber/activated carbon filter 928 may be coupled to, either directly or indirectly, a process vent 934 whereby the cleaned process gas is flowed from the scrubber/activated carbon filter 928 to the process vent 934 via line 932. The process vent 934 may be configured to release the cleaned process gas into the surrounding atmosphere and/or collected for further use.

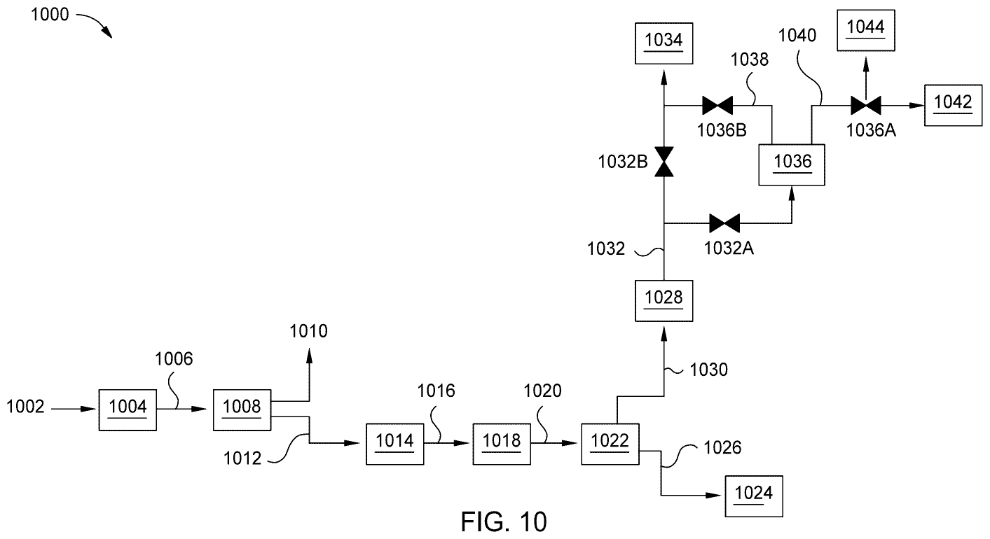

In some embodiments, a method 1000 of H₂ recovery can be illustrated by FIG. 10. The method 1000 includes introducing a feed 1002 (e.g., feed 102) to a reactor 1004 (e.g., reaction vessel 200) to produce one or more carbonaceous materials (e.g., carbon nanomaterials) and a gaseous byproduct. The feed 1002 can be any suitable feed described herein. The reactor 1004 may be coupled to, either directly or indirectly, the product filter apparatus 1008 (e.g., product filter system 300) such that the carbonaceous materials and gaseous byproducts are transferred from the reactor 1004 to the product filter apparatus 1008 via line 1006. The product filter apparatus 1008 can adopt any one or more of the configurations previously described such that the carbonaceous materials 1010 produced from the reactor 1004 are completely removed from the gaseous byproduct, thereby producing a filtered effluent stream (e.g., filtered effluent stream 314). The product filter apparatus 1008 may be coupled to, either directly or indirectly, a fin fan apparatus 1014 (e.g., fin fan cooling apparatus 400), such that the filtered effluent stream produced from the product filter apparatus 1008 is flowed therefrom to the fin fan apparatus 1014 via line 1012. The fin fan apparatus 1014 can adopt any one or more of the configurations previously described such that the filtered effluent stream produced from the product filter apparatus 1008 is sufficiently cooled to a temperature of about 50° C. to about 100° C., such as about 50° C. to about 75° C., such as about 50° C. to about 65° C., thereby producing a cooled effluent stream. The fin fan apparatus 1014 may be coupled to, either directly or indirectly, a effluent chiller apparatus 1018 (e.g., effluent chiller 500), such that the cooled effluent stream produced from the fin fan apparatus 1014 is flowed therefrom to the effluent chiller apparatus 1018 via line 1016. The effluent chiller apparatus 1018 can adopt any one or more of the configurations previously described such that the cooled effluent stream produced from the fin fan apparatus 1014 is sufficiently chilled to a temperature of about 0° C. to about 20° C., such as about 5° C. to about 15° C., such as about 5° C. to about 10° C. to condense the effluent stream, thereby producing a gas/liquid mixture (e.g., gas/liquid mixture 522). The effluent chiller apparatus 1018 may be coupled to, either directly or indirectly, a gas/liquid separator 1022 (e.g., gas/liquid separator 600), such that the gas/liquid mixture produced from the effluent chiller apparatus 1018 is flowed therefrom to the gas/liquid separator 1022 via line 1020. The gas/liquid separator 1022 can adopt any one or more of the configurations previously described such that the gas/liquid mixture produced from the effluent chiller apparatus 1018 is able to sufficiently separate the product gas (e.g., gaseous output 116 and/or gaseous output 610) and waste liquid output (e.g., liquid output 118 and/or liquid output 612).

In one or more embodiments, the gas/liquid separator 1022 is configured to include a control valve (e.g., control valve 628) and a liquid outlet (e.g., liquid phase outlet 622), wherein the control valve separates the gas/liquid separator from the liquid outlet. The liquid outlet may be coupled to, either directly or indirectly, a waste liquid containment unit 1024, such that the control valve separating the gas/liquid separator 1022 from the liquid outlet can be opened enough to maintain a sufficient vapor pressure in the headspace of the gas/liquid separator 1022 and flow the excess waste liquid output from the gas/liquid separator 1022 flows to the waste liquid containment unit 1024 via line 1026. The waste liquid containment unit 1024 is configured to have robust physical and mechanical properties such that it provides safe and stable storage and transport therefrom to a suitable waste treatment facility.

Additionally, the gas/liquid separator 1022 may be configured to include a mist extractor (e.g., mist extraction apparatus 630) coupled to a gas outlet (e.g., pas phase outlet 632) by which the product gas may be removed from the gas/liquid separator 1022. Without being bound by theory, the vapor pressure present in the headspace of the gas/liquid separator 1022 provides a sufficient force to flow the product gas through the mist extractor and the gas outlet coupled thereto. The gas outlet is coupled to, either directly or indirectly, a scrubber/activated carbon filter 1028, such that the product gas produced from the gas/liquid separator 1022 may be flowed therefrom to the scrubber/activated carbon filter 1028 via line 1030. The scrubber/activated carbon filter 1028 (e.g., a desiccant bed) is configured to remove any residual solvents/hydrocarbon solvents remaining in the product gas from the gas/liquid separator 1022 to produce a cleaned process gas (e.g., gaseous output 610).

The scrubber/activated carbon filter 1028 may be coupled to, either directly or indirectly, a PSA 1036 (e.g., PSA 800) and/or a process vent 1034 such that the cleaned process gas may be flowed to either component via line 1032 and one or more valves, such as valves 1032A and 1032B (e.g., directional control valves 808a-808d). The cleaned process gas may be flowed directly from the scrubber/activated carbon filter 1028 to the process vent 1034 via line 1032 and valve 1032B, such that the cleaned process gas is released directly into the surrounding atmosphere and/or collected for further use. The cleaned process gas may be flowed directly from the scrubber/activated carbon filter 1028 to the PSA 1036 via line 1032 and valve 1032A, wherein the PSA 1036 operates under suitable functions/conditions so as to separate H₂ gas from the cleaned process gas.

The PSA 1036 may be coupled to, either directly or indirectly, the process vent 1034 via line 1038 and/or valve 1036B, such that the cleaned waste process gas produced by the PSA 1036, as a result of H₂ gas separation, can be released into the surrounding atmosphere and/or collected for further use. Additionally or alternatively, the PSA 1036 is coupled to, either directly or indirectly, to a H₂ gas recovery storage/containment unit 1042 via line 1040 and/or valve 1036A, wherein separated H₂ gas from the PSA 1036 may be collected and stored. In at least one embodiment, valve 1036A may be configured as a directional control valve so as to direct the separated H₂ gas from the PSA 1036 to the H₂ gas recovery storage/containment unit 1042. In an alternative embodiment, valve 1036 A may be configured as a directional control valve so as to direct the separated H₂ gas from the PSA 1036 to be recycled/reintroduced 1044 to the method 1000 as a feed gas and/or carrier gas.

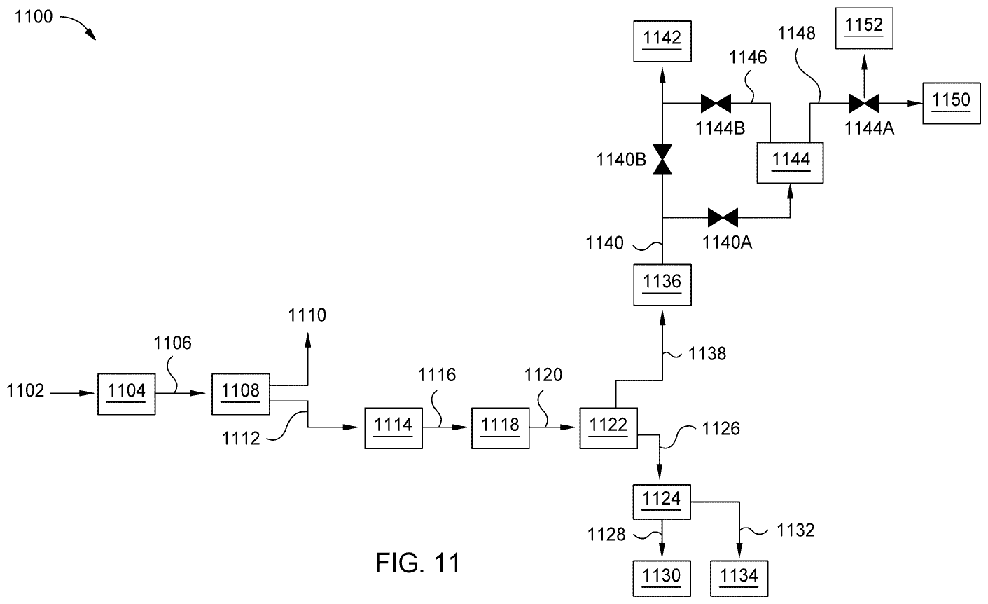

In some embodiments, a method 1100 of H₂ recovery can be illustrated by FIG. 11. The method 1100 includes introducing a feed 1102 (e.g., feed 102) to a reactor 1104 (e.g., reaction vessel 200) to produce one or more carbonaceous materials (e.g., carbon nanomaterials) and a gaseous byproduct. In at least one embodiment, the feed 1102 can be any suitable feed described herein. The reactor 1104 may be coupled to, either directly or indirectly, the product filter apparatus 1108 (e.g., product filter system 300) such that the carbonaceous materials and gaseous byproducts are transferred from the reactor 1104 to the product filter apparatus 1108 via line 1106. The product filter apparatus 1108 can adopt any one or more of the configurations previously described such that the product carbonaceous materials 1110 produced from the reactor 1104 are completely removed from the gaseous byproduct stream, thereby producing a filtered effluent stream (e.g., filtered effluent stream 314). The product filter apparatus 1108 may be coupled to, either directly or indirectly, a fin fan apparatus 1114 (e.g., fin fan cooling apparatus 400), such that the filtered effluent stream produced from the product filter apparatus 1108 is flowed therefrom to the fin fan apparatus 1114 via line 1112. The fin fan apparatus 1114 can adopt any one or more of the configurations previously described such that the filtered effluent stream produced from the product filter apparatus 1108 is sufficiently cooled to a temperature of about 50° C. to about 100° C., such as about 50° C. to about 75° C., such as about 50° C. to about 65° C., thereby producing a cooled effluent stream. The fin fan apparatus 1114 may be coupled to, either directly or indirectly, an effluent chiller apparatus 1118 (e.g., effluent chiller 500), such that the cooled effluent stream produced from the fin fan apparatus 1114 is flowed therefrom to the effluent chiller apparatus 1118 via line 1116. The effluent chiller apparatus 1118 can adopt any one or more of the configurations previously described such that the cooled effluent stream produced from the fin fan apparatus 1114 is sufficiently chilled to a temperature of about 0° C. to about 20° C., such as about 5° C. to about 15° C., such as about 5° C. to about 10° C. to condense the effluent stream, thereby producing a gas/liquid mixture (e.g., gas/liquid mixture 522). The effluent chiller apparatus 1118 may be coupled to, either directly or indirectly, a gas/liquid separator 1122 (e.g., gas/liquid separator 600), such that the gas/liquid mixture produced from the effluent chiller apparatus 1118 is flowed therefrom to the gas/liquid separator 1122 via line 1120. The gas/liquid separator 1122 can adopt any one or more of the configurations previously described such that the gas/liquid mixture produced from the effluent chiller apparatus 1118 is able to sufficiently separate the product gas (e.g., gaseous output 116 and/or gaseous output 610) and waste liquid output (e.g., liquid output 118 and/or liquid output 612).

The gas/liquid separator 1122 may be configured to include a control valve (e.g., control valve 628) and a liquid outlet (e.g., liquid phase outlet 622), wherein the control valve separates the gas/liquid separator from the liquid outlet. The liquid outlet may be coupled to, either directly or indirectly, a decanter unit 1124 (e.g., decanter vessel 700), such that the control valve separating the gas/liquid separator 1122 from the liquid outlet can be opened enough to maintain a sufficient vapor pressure in the headspace of the gas/liquid separator 1122 and flow the excess waste liquid output from the gas/liquid separator 1122 is flowed to the decanter unit 1124 via line 1126. The decanter unit 1124 is configured to effectively and/or efficiently separate high density liquids (e.g., high density phase 708) from low density liquids (e.g., low density phase 706). In at least one embodiment, the high density liquids can be drained from the bottom of the decanter unit 1124 via line 1128 into a suitable containment apparatus 1130. In at least one embodiment, the low density liquids can be separated from the high density liquids via line 1132 and collected/stored within a suitable containment apparatus 1134. In some embodiments, the high density liquids and/or low density liquids may be recycled for use in one or more additional methods.

Additionally, the gas/liquid separator 1122 is configured to include a mist extractor (e.g., mist extraction apparatus 630) coupled to a gas outlet (e.g., gas phase outlet 632) by which the product gas may be removed from the gas/liquid separator 1122. Without being bound by theory, the vapor pressure present in the headspace of the gas/liquid provides a sufficient pressure to flow the product gas output through the mist extractor and the gas outlet coupled thereto. The gas outlet may be coupled to, either directly or indirectly, a scrubber/activated carbon filter 1136, such that the product gas output produced from the gas/liquid separator 1122 may be flowed therefrom to the scrubber/activated carbon filter 1136 via line 1138. The scrubber/activated carbon filter 1136 (e.g., a desiccant bed) is configured to remove any residual solvents/hydrocarbon solvents remaining in the product gas output from the gas/liquid separator 1122 to produce a cleaned process gas.

The scrubber/activated carbon filter 1136 may be coupled to, either directly or indirectly, a PSA 1144 (e.g., PSA 800) and/or a process vent 1142 such that the cleaned process gas may be flowed to either component via line 1140 and one or more valves, such as valves 1140A and 1140B (e.g., directional control valves 808a-808d). The cleaned process gas may be flowed directly from the scrubber/activated carbon filter 1136 to the process vent 1142 via line 1140 and valve 1140B, such that the cleaned process gas is released directly into the surrounding atmosphere. The cleaned process gas may be flowed directly from the scrubber/activated carbon filter 1136 to the PSA 1144 via line 1032 and valve 1032A, wherein the PSA 1144 operates under suitable functions/conditions so as to separate H₂ gas from the cleaned process gas.

The PSA 1144 may be coupled to, either directly or indirectly, the process vent 1142 via line 1146 and/or valve 1144B, such that the cleaned waste process gas produced by the PSA 1144 can be released into the surrounding atmosphere and/or collected for further use. Additionally or alternatively, the PSA 1144 may be coupled to, either directly or indirectly, to a H₂ gas recovery storage/containment unit 1150 via line 1148 and/or valve 1144A, wherein separated H₂ gas from the PSA 1144 may be collected and stored. The valve 1144A may be configured as a directional control valve so as to direct the separated H₂ gas from the PSA 1144 to the H₂ gas recovery storage/containment unit 1150 or to be recycled/reintroduced 1152 to the method 1100 as a feed gas and/or carrier gas.

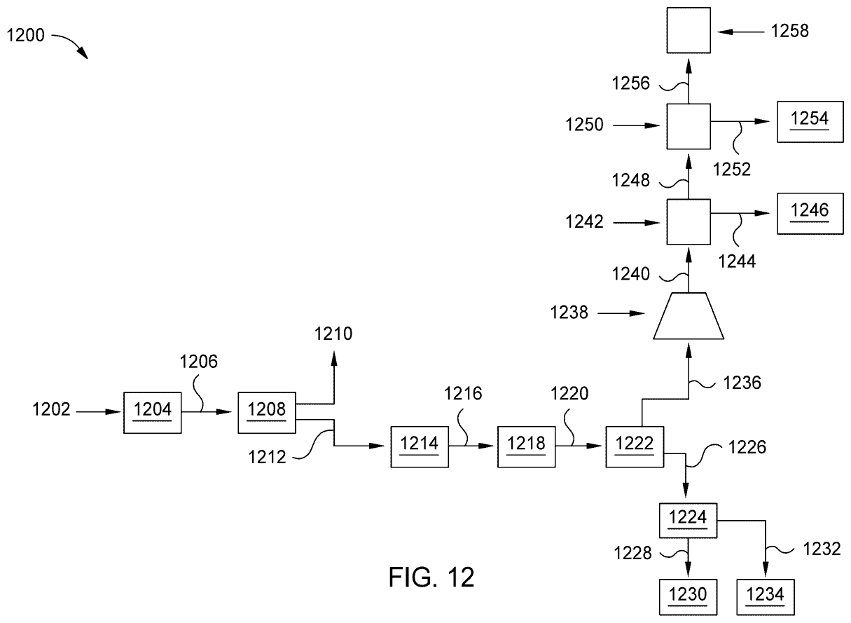

In some embodiments, a method of H₂ recovery can be illustrated by FIG. 12. The method 1200 includes introducing a feed 1202 (e.g., feed 102) to a reactor 1204 (e.g., reaction vessel 200) to produce one or more carbonaceous materials (e.g., carbon nanomaterials) and a gaseous byproduct. In at least one embodiment, the feed 1202 can be any suitable feed described herein. The reactor 1204 may be coupled to, either directly or indirectly, the product filter apparatus 1208 (e.g., product filter system 300) such that the carbonaceous materials and gaseous byproducts are transferred from the reactor 1204 to the product filter apparatus 1208 via line 1206. The product filter apparatus 1208 can adopt any one or more of the configurations previously described such that the product carbonaceous materials 1210 produced from the reactor 1204 are completely removed from the gaseous byproduct stream, thereby producing a filtered effluent stream (e.g., filtered effluent stream 314). In one or more embodiments, the product filter apparatus 1208 is coupled to, either directly or indirectly, a fin fan apparatus 1214 (e.g., fin fan cooling apparatus 400), such that the filtered effluent stream produced from the product filter apparatus 1208 is flowed therefrom to the fin fan apparatus 1214 via line 1212. The fin fan apparatus 1214 can adopt any one or more of the configurations previously described such that the filtered effluent stream produced from the product filter apparatus 1208 is sufficiently cooled to a temperature of about 50° C. to about 100° C., such as about 50° C. to about 75° C., such as about 50° C. to about 65° C., thereby producing a cooled effluent stream. The fin fan apparatus 1214 may be coupled to, either directly or indirectly, an effluent chiller apparatus 1218 (e.g., effluent chiller 500), such that the cooled effluent stream produced from the fin fan apparatus 1214 is flowed therefrom to the effluent chiller apparatus 1218 via line 1216. The effluent chiller apparatus 1218 can adopt any one or more of the configurations previously described such that the cooled effluent stream produced from the fin fan apparatus 1214 is sufficiently chilled to a temperature of about 0° C. to about 20° C., such as about 5° C. to about 15° C., such as about 5° C. to about 10° C. such to condense the effluent stream, thereby producing a gas/liquid mixture (e.g., gas/liquid mixture 522). The effluent chiller apparatus 1218 may be coupled to, either directly or indirectly, a gas/liquid separator 1222, such that the gas/liquid mixture produced from the effluent chiller apparatus 1218 is flowed therefrom to the gas/liquid separator 1222 via line 1220. The gas/liquid separator 1222 can adopt any one or more configurations previously described, such that the gas/liquid mixture produced from the effluent chiller apparatus 1218 is able to sufficiently separate the product gas (e.g., gaseous output 116 and/or gaseous output 610) and waste liquid output (e.g., liquid output 118 and/or liquid output 612).

In one or more embodiments, the gas/liquid separator 1222 is configured to include a control valve (e.g., control valve 628) and a liquid outlet (e.g., liquid phase outlet 622), wherein the control valve separates the gas/liquid separator from the liquid outlet. The liquid outlet may be coupled to, either directly or indirectly, a decanter unit 1224 (e.g., decanter vessel 700), such that the control valve separating the gas/liquid separator 1222 from the liquid outlet can be opened enough to maintain a sufficient vapor pressure in the headspace of the gas/liquid separator 1222 and flow the excess waste liquid output from the gas/liquid separator 1222 to the decanter unit 1224 via line 1226. The decanter unit 1224 is configured to effectively and/or efficiently separate high density liquids (e.g., high density phase 708) from low density liquids (e.g., low density phase 706). In at least one embodiment, the high density liquids can be drained from the bottom of the decanter unit 1224 via line 1228 into a suitable containment apparatus 1230. In at least one embodiment, the low density liquids can be separated from the high density liquids via line 1232 and collected/stored within a suitable containment apparatus 1234. The high density liquids and/or low density liquids may be recycled for use in one or more additional methods.

Additionally, the gas/liquid separator 1222 is configured to include a mist extractor (e.g., mist extraction apparatus 630) coupled to a gas outlet (e.g., gas phase outlet 632) by which the product gas may be removed from the gas/liquid separator 1222. Without being bound by theory, the vapor pressure present in the headspace of the gas/liquid provides a sufficient force to flow the process gas output through the mist extractor and the gas outlet coupled thereto. The gas outlet may be coupled to, either directly or indirectly, a compressor 1238 wherein the process gas output is flowed thereto via line 1236. The compressor 1238 is configured to provide a flow of compressed product gas to a H₂ recovery membrane 1242, via line 1240, and a VoC recovery membrane 1250, via line 1248. In some embodiments, the compressor 1238 is coupled to the H₂ recovery membrane 1242 via line 1240 such that the compressed process gas provided by the compressor enters a first end of the H₂ recovery membrane 1242 so as to capture the H₂ gas within the compressed process gas. Without being bound by theory, the pressure provided from the compressor 1238 provides an adequate force necessary to produce a flow profile of the compressed process gas throughout the H₂ recovery membrane 1242, such that the compressed process gas is stripped of any amount of H₂ gas. In some embodiments, the H₂ recovery membrane 1242 is coupled to the VoC recovery membrane 1250 via line 1248. Without being bound by theory, the pressure provided from the gas flow through the H₂ recovery membrane 1242 provides an adequate force to produce a gas flow profile from the H₂ recovery membrane to and/or throughout the VoC recovery membrane 1250, such that any one or more VoCs are stripped from product gas to produce a waste gas. The VoC recovery membrane 1250 may be coupled to, either directly or indirectly, a process vent 1258 via line 1256 such that the waste gas flowing from the VoC recovery membrane 1250 is released into the surrounding atmosphere and/or collected for further use. The H₂ recovery membrane 1242 and/or the VoC recovery membrane 1250 may undergo a membrane regeneration process by which the entrapped products of the respective membranes are collected, stored, and/or recycled for additional use. As such, the H₂ recovery membrane 1242 may additionally be coupled to, either directly or indirectly, a H₂ gas storage/containment unit 1246, via line 1244, to collect H₂ gas released from regenerating the H₂ recovery membrane 1242 after stripping H₂ gas from the compressed process gas. Additionally or alternatively, the VoC recovery membrane 1250 may be coupled to, either directly or indirectly, a VoC storage/containment unit 1254, via line 1252, to collect VoCs released from regenerating the VoC recovery membrane 1250 after stripping various VoCs from the product gas.

### Additional Aspects

The present disclosure provides, among others, the following embodiments, each of which may be considered as optionally including any alternate embodiments.

Clause 1. An apparatus, comprising:
a reactor;
a product filter system;
a fin fan cooling apparatus;
an effluent chiller;
a gas/liquid separator;
a waste liquid containment unit;
an activated carbon filter; and
a process vent.

Clause 2. The apparatus of clause 1, wherein the reactor comprises:
a tube substrate disposed laterally within a multi-zone furnace such that the furnace surrounds the tube;
an injector coupled to the tube via a first coupling, wherein the injector is in fluid communication with a volume of the tube via an inlet;
a pump coupled to the injector, wherein the pump and injector are configured such that the pump may produce a positive and a negative pressure within a volume of the injector to load and unload the volume with a feed; and a carrier gas source in fluid communication with the volume of the tube, wherein the carrier gas source is coupled to a gas flow controller.

Clause 3. The apparatus of clause 2, wherein the multi-zone furnace comprises 1 to 10 zones.

Clause 4. The apparatus of Clause 2 or Clause 3, wherein the multi-zone furnace comprises 2 to 8 zones.

Clause 5. The apparatus of any one of clauses 2-4, wherein the multi-zone furnace comprises 4 to 6 zones.

Clause 6. The apparatus of any one of clauses 2-3, wherein the multi-zone furnace comprises 5 to 10 zones.

Clause 7. The apparatus of any one of clauses 2-6, wherein the multi-zone furnace comprises one or more heating coils.

Clause 8. The apparatus of any one of clauses 2-7, wherein the tube comprises a length of about 1 m to about 5 m.

Clause 9. The apparatus of any one of clauses 2-8, wherein the tube comprises an inner diameter of about 12 mm to about 100 mm.

Clause 10. The apparatus of any one of clauses 2-9, wherein the tube comprises a first conduit coupled to the gas flow controller and a second conduit.

Clause 11. The apparatus of any one of clauses 1-10, wherein the reactor is directly coupled to the product filter system.

Clause 12. The apparatus of any one of clauses 1-11, wherein the product filter system comprises:
a catalyst separation unit coupled to the second conduit of the tube;
a product filter apparatus coupled to the catalyst separation unit;
a product capture vessel coupled to the product filter apparatus;
a nitrogen supply coupled to the product filter apparatus; and
a filtered effluent exhaust coupled to the product filter apparatus.

Clause 13. The apparatus of clause 12, wherein the product filter apparatus further comprises a separation mechanism.

Clause 14. The apparatus of clause 13, wherein the separation mechanism is selected from the group consisting of a cyclonic separator, a multicyclonic separator, an electrostatic precipitator, a magnetic separator, an inertial separator, a gravity separator, a filter, and combinations thereof.

Clause 15. The apparatus of clause 13 or clause 14, wherein the separation mechanism comprises a filter, wherein the filter is selected from the group consisting of a sintered ceramic filter, a sintered metal filter, and combinations thereof.

Clause 16. The apparatus of any one of clauses 1-15, wherein the product filter system is directly coupled to the fin fan cooling apparatus.

Clause 17. The apparatus of clause 16, wherein the fin fan cooling apparatus is coupled to the product filter system via the filtered effluent exhaust.

Clause 18. The apparatus of any one of clauses 1-17, wherein the fin fan cooling apparatus comprises:
a finned tube bundle mounted in connection to a fan deck, wherein the fan deck is configured to distribute the air evenly across the finned tube bundle; and
one or more fans coupled to the fan deck.

Clause 19. The apparatus of clause 18, wherein the finned tube bundle comprises a pipe and one or more fins.

Clause 20. The apparatus of clause 19, wherein the pipe comprises an inlet and an outlet, wherein the inlet is directly coupled to the filtered effluent exhaust of the product filter system.

Clause 21. The apparatus of clause 20, wherein the pipe comprises a length of about 1 m to about 100 m.

Clause 22. The apparatus of clause 20 or clause 21, wherein the pipe comprises a length of about 1 m to about 2.5 m.

Clause 23. The apparatus of any one of clauses 20-22, wherein the pipe comprises 1 to 100 piping loops.

Clause 24. The apparatus of any one of clauses 20-23, wherein the pipe comprises 1 to 10 piping loops.

Clause 25. The apparatus of any one of clauses 20-24, wherein the pipe is made of a material selected from the group consisting of carbon steel, stainless steel, duplex, copper, aluminum, Incoloy 800, and combinations thereof.

Clause 26. The apparatus of any one of clauses 20-25, wherein the finned tube bundle comprises fins having a fin height of about 6.3 mm to about 25.4 mm.

Clause 27. The apparatus of any one of clauses 20-26, wherein the finned tube bundle comprises fins having a fin thickness of about 0.3 mm to about 1.5 mm.

Clause 28. The apparatus of any one of clauses 20-27, wherein the fin fan cooling apparatus comprises 1 to 50 fans.

Clause 29. The apparatus of any one of clauses 20-28, wherein the fin fan cooling apparatus comprises 1 to 5 fans.

Clause 30. The apparatus of any one of clauses 1-29, wherein the fin fan cooling apparatus is directly coupled to the effluent chiller.

Clause 31. The apparatus of clause 30, wherein the effluent chiller is a shell and tube type heat exchanger comprising:
a tube side inlet and a tube side outlet separated by a series of 10 to 50 tubes;
a shell side inlet and a shell side outlet separated by a series of 1 to 25 baffles; and
a cooling media.

Clause 32. The apparatus of clause 31, wherein the outlet of the fin fan cooling apparatus is coupled to a tube side inlet of the effluent chiller.

Clause 33. The apparatus of clause 31, wherein the outlet of the fin fan cooling apparatus is coupled to a shell side inlet of the effluent chiller.

Clause 34. The apparatus of any one of clauses 31-33, wherein each of the tubes has a diameter of about 6.3 mm to about 25.4 mm.

Clause 35. The apparatus of any one of clauses 31-34, wherein each of the tubes has a distance of about 0.5 m to about 4 m.

Clause 36. The apparatus of any one of clauses 1-35, wherein the effluent chiller is directly coupled to the gas/liquid separator.

Clause 37. The apparatus of any one of clauses 1-36, wherein the gas/liquid separator comprises:
an inlet coupled to an outlet of the effluent chiller;
an inlet device coupled to the inlet;
a control valve coupled to a liquid outlet; and
a gas outlet coupled to a mist extraction apparatus.

Clause 38. The apparatus of clause 37, wherein the inlet device of the gas/liquid separator is a diverter plate.

Clause 39. The apparatus of any one of clauses 37-38, wherein the mist extraction apparatus is selected from the group consisting of a mesh pad extractor, a vane-type extractor, an axial flow demisting cyclone, and combinations thereof.

Clause 40. The apparatus of any one of clauses 37-39, wherein the liquid outlet is coupled to the waste liquid containment unit.

Clause 41. The apparatus of any one of clauses 37-40, wherein the gas outlet is coupled to the activated carbon filter.

Clause 42. The apparatus of any one of clauses 1-41, wherein the gas/liquid separator is coupled to the waste liquid containment unit.

Clause 43. The apparatus of any one of clauses 1-42, wherein the gas/liquid separator is coupled to the activated carbon filter.

Clause 44. The apparatus of any one of clauses 1-43, wherein the activated carbon filter is coupled to the process vent.

Clause 45. An apparatus, comprising:
a reactor;
a product filter system;
a fin fan cooling apparatus;
an effluent chiller;
a gas/liquid separator;
an activated carbon filter;
an H₂ recovery package;
a process vent; and
a waste liquid recovery unit.

Clause 46. The apparatus of clause 45, wherein the reactor comprises:
a tube substrate disposed laterally within a multi-zone furnace such that the furnace surrounds the tube;
an injector coupled to the tube via a first coupling, wherein the injector is in fluid communication with a volume of the tube via an inlet;
a pump coupled to the injector, wherein the pump and injector are configured such that the pump may produce a positive and a negative pressure within a volume of the injector to load and unload the volume with a feed; and
a carrier gas source in fluid communication with the volume of the tube, wherein the carrier gas source is coupled to a gas flow controller.

Clause 47. The apparatus of clause 46, wherein the multi-zone furnace comprises 1 to 10 zones.

Clause 48. The apparatus of clause 46 or clause 47, wherein the multi-zone furnace comprises 2 to 8 zones.

Clause 49. The apparatus of any one of clauses 46-48, wherein the multi-zone furnace comprises 4 to 6 zones.

Clause 50. The apparatus of any one of clauses 46-47, wherein the multi-zone furnace comprises 5 to 10 zones.

Clause 51. The apparatus of any one of clauses 46-50, wherein the multi-zone furnace comprises one or more heating coils.

Clause 52. The apparatus of any one of clauses 46-51, wherein the tube comprises a length of about 1 m to about 5 m.

Clause 53. The apparatus of any one of clauses 46-52, wherein the tube comprises an inner diameter of about 12 mm to about 100 mm.

Clause 54. The apparatus of any one of clauses 46-53, wherein the tube comprises a first conduit coupled to the gas flow controller and a second conduit.

Clause 55. The apparatus of any one of clauses 45-53, wherein the reactor is directly coupled to the product filter system.

Clause 56. The apparatus of any one of clauses 45-55, wherein the product filter system comprises:
a catalyst separation unit coupled to the second conduit of the tube;
a product filter apparatus coupled to the catalyst separation unit;
a product capture vessel coupled to the product filter apparatus;
a nitrogen supply coupled to the product filter apparatus; and
a filtered effluent exhaust coupled to the product filter apparatus.

Clause 57. The apparatus of clause 56, wherein the product filter apparatus further comprises a separation mechanism.

Clause 58. The apparatus of clause 57, wherein the separation mechanism is selected from the group consisting of a cyclonic separator, a multicyclonic separator, an electrostatic precipitator, a magnetic separator, an inertial separator, a gravity separator, a filter, and combinations thereof.

Clause 59. The apparatus of clause 57 or clause 58, wherein the separation mechanism comprises a filter, wherein the filter is selected from the group consisting of a sintered ceramic filter, a sintered metal filter, and combinations thereof.

Clause 60. The apparatus of any one of clauses 45-59, wherein the product filter system is directly coupled to the fin fan cooling apparatus.

Clause 61. The apparatus of clause 60, wherein the fin fan cooling apparatus is coupled to the product filter system via the filtered effluent exhaust.

Clause 62. The apparatus of any one of clauses 45-61, wherein the fin fan cooling apparatus comprises:
a finned tube bundle mounted in connection to a fan deck, wherein the fan deck is configured to distribute the air evenly across the finned tube bundle; and
one or more fans coupled to the fan deck.

Clause 63. The apparatus of clause 62, wherein the finned tube bundle comprises a pipe and one or more fins.

Clause 64. The apparatus of clause 63, wherein the pipe comprises an inlet and an outlet, wherein the inlet is directly coupled to the filtered effluent exhaust of the product filter system.

Clause 65. The apparatus of clause 64, wherein the pipe comprises a length of about 1 m to about 100 m.

Clause 66. The apparatus of clause 64 or clause 65, wherein the pipe comprises a length of about 1 m to about 2.5 m.

Clause 67. The apparatus of any one of clauses 64-66, wherein the pipe comprises 1 to 100 piping loops.

Clause 68. The apparatus of any one of clauses 64-67, wherein the pipe comprises 1 to 10 piping loops.

Clause 69. The apparatus of any one of clauses 64-68, wherein the pipe is made of a material selected from the group consisting of carbon steel, stainless steel, duplex, copper, aluminum, Incoloy 800, and combinations thereof.

Clause 70. The apparatus of any one of clauses 64-69, wherein the finned tube bundle comprises fins having a fin height of about 6.3 mm to about 25.4 mm.

Clause 71. The apparatus of any one of clauses 64-70, wherein the finned tube bundle comprises fins having a fin thickness of about 0.3 mm to about 1.5 mm.

Clause 72. The apparatus of any one of clauses 64-71, wherein the fin fan cooling apparatus comprises 1 to 50 fans.

Clause 73. The apparatus of any one of clauses 64-72, wherein the fin fan cooling apparatus comprises 1 to 5 fans.

Clause 74. The apparatus of any one of clauses 44-73, wherein the fin fan cooling apparatus is directly coupled to the effluent chiller.

Clause 75. The apparatus of clause 74, wherein the effluent chiller is a shell and tube type heat exchanger comprising:
a tube side inlet and a tube side outlet separated by a series of 10 to 50 tubes;
a shell side inlet and a shell side outlet separated by a series of 1 to 25 baffles; and
a cooling media.

Clause 76. The apparatus of clause 75, wherein the outlet of the fin fan cooling apparatus is coupled to a tube side inlet of the effluent chiller.

Clause 77. The apparatus of clause 75, wherein the outlet of the fin fan cooling apparatus is coupled to a shell side inlet of the effluent chiller.

Clause 78. The apparatus of any one of clauses 75-77, wherein each of the tubes has a diameter of about 6.3 mm to about 25.4 mm.

Clause 79. The apparatus of any one of clauses 75-78, wherein each of the tubes has a distance of about 0.5 m to about 4 m.

Clause 80. The apparatus of any one of clauses 45-79, wherein the effluent chiller is directly coupled to the gas/liquid separator.

Clause 81. The apparatus any one of clauses 45-80, wherein the gas/liquid separator comprises:
an inlet coupled to an outlet of the effluent chiller;
an inlet device coupled to the inlet;
a control valve coupled to a liquid outlet; and
a gas outlet coupled to a mist extraction apparatus.

Clause 82. The apparatus of clause 81, wherein the inlet device of the gas/liquid separator is a diverter plate.

Clause 83. The apparatus of clause 81 or clause 82, wherein the mist extraction apparatus is selected from the group consisting of a mesh pad extractor, a vane-type extractor, an axial flow demisting cyclone, and combinations thereof.

Clause 84. The apparatus of any one of clauses 81-83, wherein the liquid outlet is coupled to the waste liquid recovery unit.

Clause 85. The apparatus of any one of clauses 81-84, wherein the gas outlet is coupled to the activated carbon filter.

Clause 86. The apparatus of any one of clauses 45-85, wherein the gas/liquid separator is coupled to the waste liquid recovery unit.

Clause 87. The apparatus of any one of clauses 45-86, wherein the gas/liquid separator is coupled to the activated carbon filter.

Clause 88. The apparatus of any one of clauses 45-87, wherein the activated carbon filter is coupled to the H₂ recovery package.

Clause 89. The apparatus of clause 88, wherein the H₂ recovery package comprises a pressure swing absorber, comprising:
a compressor coupled to the activated carbon filter;
one or more absorption towers coupled to the compressor via one or more of directional control valves;
a master control valve coupled to the one or more absorption towers via the one or more directional control valves;
a H₂ storage unit coupled to the master control valve; and
a gas recirculation line coupled to the master control valve.

Clause 90. The apparatus of clause 89, wherein the one or more absorption towers comprises 1 to 20 absorption towers.

Clause 91. The apparatus of clause 89 or clause 90, wherein the one or more absorption towers comprises 1 to 4 absorption towers.

Clause 92. The apparatus of any one of clauses 89-91, wherein each of the one or more absorption towers comprises one or more absorbents comprising zeolites, activated carbon, silica gel, alumina, synthetic resins, molecular sieves, metal-organic frameworks (MOFs), or combinations thereof.

Clause 93. The apparatus of any one of clauses 89-92, wherein the master control valve is configured to determine a directional flow to either the H₂ storage unit or the gas recirculation line.

Clause 94. The apparatus of any one of clauses 45-93, wherein the process vent is coupled to the H₂ recovery package.

Clause 95. The apparatus of any one of clauses 89-94, wherein the process vent is coupled to the pressure swing absorber.

Clause 96. The apparatus of any one of clauses 88, wherein the H₂ recovery unit comprises: a compressor coupled to the activated carbon filter;
an H₂ recovery membrane coupled to the compressor;
a volatile organic content (VoC) recovery membrane coupled to the H₂ recovery membrane;
a process vent coupled to the VoC recovery membrane;
an H₂ gas storage unit coupled to the H₂ recovery membrane; and
a VoC storage unit coupled to the VoC recovery membrane.

Clause 97. The apparatus of any one of clauses 45-96, wherein the waste liquid recovery unit comprises:
a decanter unit coupled to the gas/liquid separator via the liquid outlet, wherein the decanter vessel comprises:
   a waste liquid inlet coupled to the gas/liquid separator via the liquid outlet;
   a high density fluid outlet coupled to a valve, wherein the valve is further coupled to a high density fluid containment unit;
   a low density fluid outlet coupled to a valve, wherein the valve is further coupled to a low density fluid containment unit; and
   a process vent.

Clause 98. A method of making a carbon nanomaterial and recovering byproducts therefrom using the apparatus of any one of clauses 1-97, the method comprising:
introducing a carbon containing feed to a reactor to produce a mixture comprising a carbon nanomaterial and a gaseous byproduct;
filtering the carbon nanomaterial from the mixture to obtain the gaseous byproduct;
cooling the gaseous byproduct to a temperature of about 0° C. to about 20° C.;
separating the gaseous byproduct into a gaseous phase and a liquid phase, wherein the liquid phase is collected and processed and the gaseous phase is vented to the surrounding atmosphere and/or collected for further use.

Clause 99. The method of clause 98, wherein the carbon containing feed comprises:
a plastic;
a catalyst; and
a solvent.

Clause 100. The method of clause 99, wherein the plastic comprises polyvinyl chloride (PVC), polystyrene (PS), bisphenol A resins, low density polyethylene (LDPE), polypropylene (PP), polymer resins, polyurethane, elastomers, polyolefins, cellulosic compounds, or combinations thereof.

Clause 101. The method of clause 99 or clause 100, wherein the plastic is a waste plastic.

Clause 102. The method of any one of clauses 99-101, wherein the catalyst comprises an iron chloride, a nickel chloride, a cobalt chloride, a copper chloride, an iron oxide, a nickel oxide, a cobalt oxide, an iron nitrate, a cobalt nitrate, a nickel nitrate, iron acetylacetonate, nickel acetylacetonate, cobalt acetylacetonat, gallium acetylacetonate, ruthenium acetylacetonate, a metallocene, or combinations thereof.

Clause 103. The method of any clauses 99-102, wherein the catalyst comprises FeCl₃, FeCl₂, NiCl₂, CoCl₂, CuCl₂, FeO, Fe₂O₃, and Fe₃O₄, NiO, Ni₂O₃, CoO, CO₂O₃, CO₃O₄, Fe(NO₃)₃, Co(NO₃)₂, Ni(NO₃)₂. Fe(C₅H₇O₂)₃, Ni(C₅H₇O₂)₂, Co(C₅H₇O₂)₂, Ga(C₅H₇O₂)₃, Ru(C₅H₇O₂)₃, or combinations thereof.

Clause 104. The method of any one of clauses 99-103, wherein the feed comprises about 0.1 wt % to about 40 wt % of the plastic in the feed.

Clause 105. The method of any one of clauses 99-104, wherein the feed comprises about 0.0001% to about 50% (w/w) of the catalyst based on the amount of plastic in the feed.

Clause 106. The method of any one of clauses 99-105, wherein the feed comprises about 0.01% to about 5% (w/w) of the catalyst based on the amount of plastic in the feed.

Clause 107. The method of any one of clauses 99-106, wherein the reactor is operated at a temperature of about 400° C. to about 1,000° C.

Clause 108. The method of any one of clauses 99-107, wherein the reactor is operated at a temperature of about 600° C. to about 900° C.

Clause 109. The method of any one of clauses 99-108, wherein the feed is introduced into the reactor via injection with a carrier gas.

Clause 110. The method of any one of clauses 99-109, wherein the carrier gas comprises helium, argon, hydrogen, nitrogen, or combinations thereof.

Clause 111. The method of any one of clauses 99-110, wherein the carrier gas flow rate into the reactor is about 0.001 L/min and about 5000 L/min.

Clause 112. The method of any one of clauses 99-111 wherein the carrier gas flow rate into the reactor is about 0.05 L/min and about 10 L/min.

Clause 113. The method of any one of clauses 99-112, wherein the feed is injected into the reactor at a flow rate of about 0.001 mL/min and about 5000 mL/min.

Clause 114. The method of any one of clauses 99-113, wherein the feed is injected into the reactor at a flow rate of 100 mL/min and about 1500 mL/min.

Clause 115. The method of any one of clauses 99-114, wherein the separating the gaseous byproduct into a gaseous phase and a liquid phase comprises separation within a gas/liquid separator for a residence time of about 1 hrs to about 24 hrs.

Clause 116. A method of making a carbon nanomaterial and recovering the byproducts therefrom using the apparatus of one of clauses 45-97, the method comprising:
introducing a carbon containing feed to a reactor to produce a mixture comprising a carbon nanomaterial and a gaseous byproduct;
filtering the carbon nanomaterial from the mixture to obtain the gaseous byproduct;
cooling the gaseous byproduct to a temperature of about 0° C. to about 20° C.;
separating the gaseous byproduct into a gaseous phase and a liquid phase;
removing H₂ gas from the gaseous phase; and
venting the remaining gaseous phase.

Clause 117. The method of clause 116, wherein the carbon containing feed comprises:
a plastic;
a of catalyst; and
a solvent.

Clause 118. The method of clause 117, wherein the plastic comprises polyvinyl chloride (PVC), polystyrene (PS), bisphenol A resins, low density polyethylene (LDPE), polypropylene (PP), polymer resins, polyurethane, elastomers, polyolefins, cellulosic compounds, or combinations thereof.

Clause 119. The method of clause 117 or clause 118, wherein the plastic comprises a waste plastic.

Clause 120. The method of any one of clauses 117-119, wherein the catalyst comprises an iron chloride, a nickel chloride, a cobalt chloride, a copper chloride, an iron oxide, a nickel oxide, a cobalt oxide, an iron nitrate, a cobalt nitrate, a nickel nitrate, an iron acetylacetonate, a nickel acetylacetonate, a cobalt acetylacetonate, a gallium acetylacetonate, a ruthenium acetylacetonate, a metallocine, or combinations thereof.

Clause 121. The method of any one clauses 117-120, wherein the catalyst comprises FeCl₃, FeCl₂, NiCl₂, CoCl₂, CuCl₂, FeO, Fe₂O₃, and Fe₃O₄, NiO, Ni₂O₃, CoO, CO₂O₃, Co₃O₄, Fe(NO₃)₃, Co(NO₃)₂, Ni(NO₃)₂. Fe(C₅H₇O₂)₃, Ni(C₅H₇O₂)₂, Co(C₅H₇O₂)₂, Ga(C₅H₇O₂)₃, Ru(C₅H₇O₂)₃, or combinations thereof.

Clause 122. The method of any one of clauses 117-121, wherein the feed comprises about 0.1 wt % to about 40 wt % plastic.

Clause 123. The method of any one of clauses 117-122, wherein the feed comprises about 0.0001% to about 50% (w/w) of the catalyst based on the amount of plastic.

Clause 124. The method of any one of clauses 117-123, wherein the feed comprises about 0.01% to about 5% (w/w) of the catalyst based on the amount of plastic.

Clause 125. The method of any one of clauses 117-124, wherein the reactor is operated at a temperature of about 400° C. to about 1,000° C.

Clause 126. The method of any one of clauses 117-125, wherein the reactor is operated at a temperature of about 600° C. to about 900° C.

Clause 127. The method of any one of clauses 117-126, wherein the feed is introduced into the reactor via injection with a carrier gas.

Clause 128. The method of any one of clauses 117-127, wherein the carrier gas comprises helium, argon, hydrogen, nitrogen, or combinations thereof.

Clause 129. The method of any one of clauses 117-128, wherein the carrier gas flow rate into the reactor is about 0.001 L/min and about 5000 L/min.

Clause 130. The method of any one of clauses 117-129 wherein the carrier gas flow rate into the reactor is about 0.05 L/min and about 10 L/min.

Clause 131. The method of any one of clauses 117-130, wherein the feed is injected into the reactor at a flow rate of about 0.001 mL/min and about 5000 mL/min.

Clause 132. The method of any one of clauses 117-131, wherein the feed is injected into the reactor at a flow rate of 100 mL/min and about 1500 mL/min.

Clause 133. The method of any one of clauses 117-132, wherein the separating the gaseous byproduct into a gaseous phase and a liquid phase comprises separation within a gas/liquid separator for a residence time of about 1 hrs to about 24 hrs.

Clause 134. The method of any one of clauses 117-133, wherein the liquid phase is collected and processed within a decanter for a residence time of about 4 hrs to about 24 hrs, such that a high density liquid of the collected liquid separates from a low density liquid of the collected liquid.

Clause 135. The method of any one of clauses 117-134, wherein removing the H₂ gas from the gaseous phase comprises:
flowing the gaseous phase through an activated carbon filter to produce a filtered gas stream;
flowing the filtered gas stream to a H₂ recovery unit; and
collecting the H₂ gas from the H₂ recovery unit.

### EXAMPLES

Carbon nanomaterial formation (as an example carbon nanotube) and subsequent hydrogen recovery was conducted using an apparatus of the present disclosure. The apparatus investigated included the following units: a furnace, a reactor, a product filter, a fin fan cooler, an effluent chiller, a gas/liquid separator, a decanter, a scrubber/activated carbon filter, and a pressure swing absorber configured as one or more of the methods previously discussed. Various aspects and parameters (e.g., feed rate, carrier gas, and/or temperatures) were investigated. Samples of the byproduct gas stream, produced from the formation of the carbon nanomaterials, were taken at various points within the process and analyzed to determine their effects on the resulting the gas composition and H₂ gas content. The gas composition was determined using gas chromatography mass spectroscopy (GC-MS).

Examples 1-3 illustrate, for example, the change in gaseous composition of the gaseous byproduct produced from carbon nanomaterial production as it is flowed through various units of an apparatus according to one or more embodiments described herein. The components of the gaseous composition can be correlated to the components of the carrier gas composition and to the temperature of the gas exiting the effluent chiller. Furthermore, the H₂ gas content within the gaseous composition progressively increases, relative to the other components therein, as it is flowed throughout each unit.

The example feed used for Examples 1-3 included polystyrene and other styrenic materials (as an example carbon containing material), ferrocene (as an example catalyst), and benzene and other benzene based materials (as an example solvent). After the feed exits the reactor of the apparatus, the gaseous byproduct enters various units as described herein.

### Example 1

The product gas flow exiting the effluent chiller was compositionally analyzed while controlling two different variables: (1) product gas temperature upon exiting the effluent chiller and (2) carrier gas composition. Selected process parameters and resulting molar composition of the product gas exiting the effluent chiller are shown in Table 1. Solvents in Table 1 refer to the various solvents used in the feed and/or solvent components which may be produced as a result of the carbon nanomaterial production process. Other gas refers to various other gases which may be produced as a result of the carbon nanomaterial production process.

TABLE 1
Selected process parameters and composition of product gas
flow exiting the effluent chiller.

| | Temp- | | | Composition of product | | | | |
|---|---|---|---|---|---|---|---|---|
| Carrier | erature | | | gas exiting the effluent | | | | |
| gas | (effluent | | | chiller (mol fraction) | | | | |
| comp- | chiller) | Flow Rate | | | | | Other | |
| osition | ° C. | kg/hr | kmol/hr | H₂ | N₂ | H₂O | gas | Solvents |
| 100% H₂ | 5 | 11.92 | 0.96 | 0.68 | 0.00 | 0.02 | 0.23 | 0.06 |
| | 20 | 11.92 | 0.96 | 0.68 | 0.00 | 0.02 | 0.23 | 0.06 |
| | 50 | 11.92 | 0.94 | 0.67 | 0.00 | 0.04 | 0.23 | 0.06 |
| 50:50 | 5 | 18.30 | 0.90 | 0.31 | 0.37 | 0.02 | 0.22 | 0.05 |
| N₂:H₂ | 20 | 18.30 | 0.90 | 0.31 | 0.37 | 0.02 | 0.22 | 0.05 |
| | 50 | 18.30 | 0.90 | 0.31 | 0.37 | 0.03 | 0.21 | 0.05 |

At this stage, the composition of the product gas exiting from the effluent chiller is strongly correlated to the identity of the carrier gas implemented within the process.

### Example 2

The product gas exiting the gas/liquid separator was compositionally analyzed while controlling two different variables: (1) product gas temperature upon exiting the effluent chiller and (2) carrier gas composition. Selected process parameters and resulting molar composition of the product gas exiting the gas/liquid separator are shown in Table 2. Solvents in Table 2 refer to the various solvents used in the feed and/or solvent components which may be produced as a result of the carbon nanomaterial production process. Other gas refers to various other gases which may be produced as a result of the carbon nanomaterial production process.

TABLE 2
Selected process parameters and composition of product
gas exiting the gas/liquid separator.

| | Temp- | | | Composition of product | | | | |
|---|---|---|---|---|---|---|---|---|
| Carrier | erature | | | gas exiting the gas/ liquid | | | | |
| gas | (effluent | | | separator (mol fraction) | | | | |
| comp- | chiller) | Flow Rate | | | | | Other | |
| osition | ° C. | kg/hr | kmol/hr | H₂ | N₂ | H₂O | gas | Solvents |
| 100% H₂ | 5 | 8.62 | 0.80 | 0.70 | 0.00 | 0.00 | 0.26 | 0.04 |
| | 20 | 9.29 | 0.81 | 0.70 | 0.00 | 0.00 | 0.25 | 0.05 |
| | 50 | 10.97 | 0.90 | 0.68 | 0.00 | 0.02 | 0.24 | 0.06 |
| 50:50 | 5 | 15.23 | 0.79 | 0.32 | 0.38 | 0.00 | 0.23 | 0.03 |
| N₂:H₂ | 20 | 15.86 | 0.80 | 0.32 | 0.38 | 0.00 | 0.23 | 0.04 |
| | 50 | 17.64 | 0.87 | 0.31 | 0.37 | 0.03 | 0.21 | 0.05 |

When exiting the gas/liquid separator, the flow rate of the product gas can be correlated to the temperature of the product gas upon exiting the effluent chiller. Generally, the higher the temperature of the product gas exiting the effluent chiller provides an increase in the flow rate of the product gas exiting the gas/liquid separator. The increase in flow rate may be due to the increased vapor pressure present in the headspace of the gas/liquid separator. However, the increase in flow rate of the product gas may come at the expense of increasing water content of the product gas exiting the gas/liquid separator due to the temperature within the gas/liquid separator and decreased residence time therein affecting condensation.

### Example 3

The product gas exiting the scrubber/activated carbon filter was compositionally analyzed while controlling two different variables: (1) product gas temperature upon exiting the effluent chiller and (2) carrier gas composition. Selected process parameters and resulting molar composition of the product gas exiting the scrubber/activated carbon filter are shown in Table 3. Solvents in Table 3 refer to the various solvents used in the feed and/or solvent components which may be produced as a result of the carbon nanomaterial production process. Other gas refers to various other gases which may be produced as a result of the carbon nanomaterial production process.

TABLE 3
Selected process parameters and composition of
product gas exiting the scrubber/activated carbon filter.

| | | | | Composition of product | | | | |
|---|---|---|---|---|---|---|---|---|
| | Temp- | | | gas exiting the | | | | |
| Carrier | erature | | | scrubber/activated | | | | |
| gas | (effluent | | | carbon filter (mol fraction) | | | | |
| comp- | chiller) | Flow Rate | | | | | Other | |
| osition | ° C. | kg/hr | kmol/hr | H₂ | N₂ | H₂O | gas | Solvents |
| 100% H₂ | 5 | 7.74 | 0.74 | 0.70 | 0.00 | 0.01 | 0.25 | 0.04 |
| | 20 | 8.34 | 0.75 | 0.69 | 0.00 | 0.01 | 0.25 | 0.05 |
| | 50 | 9.05 | 0.77 | 0.69 | 0.00 | 0.02 | 0.24 | 0.06 |
| 50:50 | 5 | 14.57 | 0.76 | 0.32 | 0.38 | 0.01 | 0.22 | 0.03 |
| N₂:H₂ | 20 | 15.12 | 0.79 | 0.32 | 0.38 | 0.01 | 0.22 | 0.03 |
| | 50 | 15.73 | 0.81 | 0.31 | 0.37 | 0.02 | 0.22 | 0.04 |

When exiting the scrubber/activated carbon filter, the flow rate of the product gas can be correlated to both the temperature of the product gas exiting the effluent chiller and the identity of the carrier gas. Generally, the higher the temperature of the product gas exiting the effluent chiller provides an increase in the flow rate of the product gas exiting the scrubber/activated carbon filter. Without being bound by theory, the temperature of the product gas exiting the effluent chiller controls the vapor pressure in the headspace of the gas/liquid separator, which provides a force that promotes gas flow throughout the H₂ recovery package. The flow rate of samples using the 50:50 N₂:H₂ carrier gas are generally higher than that of the 100% H₂ carrier gas. However, the N₂ content of the 50:50 N₂:H₂ carrier gas presents an additional component to the product gas exiting the scrubber/activated carbon filter, which is removed in subsequent operations to collect and store high purity H₂ gas. As such, the use of the 100% H₂ carrier gas may provide easier recovery of high purity H₂ gas from the product gas exiting the scrubber/activated carbon filter, albeit at the expense of gas flow rate.

Overall, apparatus and methods disclosed herein offer facile routes and/or effective methods for treating, disposing, and/or collecting the product gas produced from the preparation of carbon nanomaterials (e.g., CNTs). Apparatus disclosed herein offers a versatile and inexpensive configuration to suit the needs and/or environmental requirements of a carbon nanomaterial production facility. Additionally, the feed used in embodiments described herein can be readily available from waste plastics that are outside of the useful lifetimes. Embodiments described herein offer routes by which the byproducts of carbon nanomaterial fabrication can be collected, stored, recycled, and/or reused thereby reducing the amount of waste commonly associated with such processes.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

1. An apparatus, comprising:
a reactor adapted to process a carbon containing feed;
a product filter system coupled to the reactor;
a fin fan cooling apparatus coupled to the product filter system;
an effluent chiller coupled to the fin fan cooling apparatus;
a gas/liquid separator coupled to the effluent chiller;
a waste liquid containment unit coupled to the gas/liquid separator;
an activated carbon filter coupled to the gas/liquid separator; and
a process vent coupled to the activated carbon filter.

2. The apparatus of claim 1, wherein the reactor comprises:
a tube substrate disposed laterally within a multi-zone furnace such that the multi-zone furnace surrounds the tube;
an injector coupled to the tube via a first coupling, the injector in fluid communication with a volume of the tube via an inlet;
a pump coupled to the injector, the pump and injector configured such that the pump produces a positive pressure and a negative pressure within a volume of the injector to load and unload the volume with a feed; and
a carrier gas source in fluid communication with the volume of the tube, wherein the carrier gas source is coupled to a gas flow controller.

3. The apparatus of one of claim 1, wherein the product filter system comprises:
a catalyst separation unit;
a product filter apparatus coupled to the catalyst separation unit;
a product capture vessel coupled to the product filter apparatus;
a nitrogen supply coupled to the product filter apparatus; and
a filtered effluent exhaust coupled to the product filter apparatus.

4. The apparatus of one of claim 1, wherein the fin fan cooling apparatus comprises:
a finned tube bundle mounted in connection to a fan deck, wherein the fan deck is configured to distribute air evenly across the finned tube bundle; and
one or more fans coupled to the fan deck.

5. The apparatus of claim 1, wherein the effluent chiller is a shell and tube type heat exchanger comprising:
a tube side inlet and a tube side outlet separated by a series of 10 to 50 tubes;
a shell side inlet and a shell side outlet separated by a series of 1 to 25 baffles; and
a cooling media.

6. The apparatus of claim 1, wherein the gas/liquid separator comprises:
an inlet;
an inlet device coupled to the inlet;
a control valve coupled to a liquid outlet; and
a gas outlet coupled to a mist extraction apparatus.

7. An apparatus, comprising:
a reactor adapted to process a carbon containing feed;
a product filter system coupled the reactor;
a fin fan cooling apparatus coupled to the product filter system;
an effluent chiller coupled to the fin fan cooling apparatus;
a gas/liquid separator coupled to the effluent chiller;
an activated carbon filter coupled to the gas/liquid separator;
an H₂ recovery package coupled to the activated carbon filter;
a process vent coupled to the H₂ recovery package; and
a waste liquid recovery unit coupled to the gas/liquid separator.

8. The apparatus of claim 7, wherein the reactor comprises:
a tube substrate disposed laterally within a multi-zone furnace such that the multi-zone furnace surrounds the tube;
an injector coupled to the tube via a first coupling, the injector in fluid communication with a volume of the tube via an inlet;
a pump coupled to the injector, the pump and injector configured such that the pump produces a positive and a negative pressure within a volume of the injector to load and unload the volume with a feed; and
a carrier gas source in fluid communication with the volume of the tube, the carrier gas source is coupled to a gas flow controller.

9. The apparatus of one of claim 7, wherein the product filter system comprises:
a catalyst separation unit;
a product filter apparatus coupled to the catalyst separation unit;
a product capture vessel coupled to the product filter apparatus;
a nitrogen supply coupled to the product filter apparatus; and
a filtered effluent exhaust coupled to the product filter apparatus.

10. The apparatus of one of claim 7, wherein the fin fan cooling apparatus comprises:
a finned tube bundle mounted in connection to a fan deck, the fan deck configured to distribute air evenly across the finned tube bundle; and
one or more fans coupled to the fan deck.

11. The apparatus of claim 7, wherein the effluent chiller is a shell and tube type heat exchanger comprising:
a tube side inlet and a tube side outlet separated by a series of 10 to 50 tubes;
a shell side inlet and a shell side outlet separated by a series of 1 to 25 baffles; and
a cooling media.

12. The apparatus of claim 7, wherein the gas/liquid separator comprises:
an inlet;
an inlet device coupled to the inlet;
a control valve coupled to a liquid outlet; and
a gas outlet coupled to a mist extraction apparatus.

13. The apparatus of claim 7, wherein the H₂ recovery package comprises at least one of a recovery membrane, an absorbant technology, or a cryogenic separation unit.

14. The apparatus of claim 7, wherein the H₂ recovery package comprises a pressure swing absorber, comprising:
a compressor coupled;
one or more absorption towers coupled to the compressor via a series of directional control valves;
a master control valve coupled to the one or more absorption towers via the series of directional control valves;
a H₂ storage unit coupled to the master control valve; and
a gas recirculation line coupled to the master control valve.

15. The apparatus of claim 7, wherein the H₂ recovery package comprises:
a compressor;
an H₂ recovery membrane coupled to the compressor;
a volatile organic content (VoC) recovery membrane coupled to the H₂ recovery membrane;
a process vent coupled to the VoC recovery membrane;
an H₂ gas storage unit coupled to the H₂ recovery membrane; and
a VoC storage unit coupled to the VoC recovery membrane.

16. The apparatus of claim 7, wherein the waste liquid recovery unit comprises:
a decanter unit the decanter unit comprises:
a waste liquid inlet;
a high density fluid outlet coupled to a valve, wherein the valve is further coupled to a high density fluid containment unit;
a low density fluid outlet coupled to a valve, wherein the valve is further coupled to a low density fluid containment unit; and
a process vent.

17. A method of making carbon nanomaterials and recovering byproducts therefrom, the method comprising:
introducing a carbon containing feed to a reactor to produce a mixture comprising a carbon nanomaterial and a gaseous byproduct;
filtering the carbon nanomaterials from the mixture in a product filter system coupled to the reactor to obtain the gaseous byproduct;
cooling the gaseous byproduct in a cooling system coupled to the product filter system to a temperature of about 0° C. to about 20° C.;
separating the gaseous byproduct in a gas/liquid separator coupled to the cooling system to obtain a gaseous phase and a liquid phase;
removing H₂ gas from the gaseous phase to produce an H₂ gas and a waste gas; and
venting the waste gas.

18. The method of claim 17, wherein removing the H₂ gas from the gaseous phase comprises:
flowing the gaseous phase through an activated carbon filter to produce a filtered gas stream comprising the H₂ gas and the waste gas;
flowing the filtered gas stream to a H₂ recovery unit; and
collecting the H₂ gas.

19. The method of claim 17, wherein the carbon containing feed comprises:
a plastic;
a catalyst; and
a solvent.

20. The method of claim 17, wherein the H₂ recovery unit comprises a pressure swing absorber, comprising:
a compressor coupled;
one or more absorption towers coupled to the compressor via one or more directional control valves;
a master control valve coupled to the one or more absorption towers via the one or more directional control valves;
a H₂ storage unit coupled to the master control valve; and
a gas recirculation line coupled to the master control valve.
